(19) United States
(12) Patent Application Publication
(10) Pub. No.: US 2010/0262515 A1
(43) Pub. Date: Oct. 14, 2010

(54) INTERINSTITUTIONAL LOAN OF ELECTRONIC CONTENT

(76) Inventor: Steven D. Brewer, St. Catharines (CA)

Correspondence Address: MERCHANT & GOULD PC, P.O. BOX 2903, MINNEAPOLIS, MN, 55402-0903, US

(21) Appl. No.: 12/631,529

(22) Filed: Dec. 4, 2009

Related U.S. Application Data
(63) Continuation of application No. 12/426,706, filed on Apr. 20, 2009, now abandoned.
(60) Provisional application No. 61/046,299, filed on Apr. 18, 2008.

(51) Int. Cl. G06Q 30/00

(52) U.S. Cl. 705/27

(57) ABSTRACT

An electronic content loan system is disclosed. The loan system includes a library server configured to store electronic content associated with a lending institution. The loan system further includes a user interface accessible to a requesting institution and configurable to display a listing of electronic content available on the library server, the electronic content including content for which limited-time access is available. The loan system also includes an order processing system configured to receive requests for limited-time access to the content and process payments associated with those requests.

### CROSS-REFERENCE TO RELATED APPLICATIONS

This application is a continuation of application Ser. No. 12/426,706, filed Apr. 20, 2009, which claims the benefit of provisional application Ser. No. 61/046,299, filed Apr. 18, 2008, which applications are incorporated herein by reference in their entirety.

### TECHNICAL FIELD

The present disclosure relates to storage and distribution of electronic content. In particular, the present disclosure relates to interinstitutional loans of electronic content.

### BACKGROUND

Institutions such as universities and libraries have limited budgets and limited space for obtaining and storing printed content, such as books, journals, microfilm, or other printed materials. To overcome budget and space constraints, these universities and libraries have instituted an inter-library loan service, which allows one institution to request a book from another institution which has that book in stock. Typical inter-library loan (ILL) services work as follows: A patron at one institution, referred to herein as a requesting institution, notes that a desired book is not in stock at that institution. The patron or a librarian at the institution determines, such as through use of online card catalogs or other systems, that the book is in circulation at another institution affiliated through the ILL service. The requesting institution sends a request for the book to that other institution, referred to herein as a lending institution. The request generally asks for use of the book for a preset amount of time, generally 2-8 weeks depending upon the required use, circulation restraints, and the popularity of the book. The lending institution, having the book in circulation, can then lend the book to the requesting institution for the requested period by obtaining the book if currently loaned and shipping the book to the requesting institution. The requesting institution can then provide the book to the relevant patron for that present amount of time. When the patron has completed their use of the book, the requesting institution can then ship the book back to the lending institution.

A number of drawbacks exist in the current ILL system. First, a large amount of administrative cost is consumed in the form of the librarians' time (at both the lending and requesting institutions) in obtaining the book for loan, as well as shipping costs of the loaned book. Additionally, while the book is loaned, the lending institution no longer has access to that book, despite its presence in the lending institution's catalog. These administrative costs are borne by the lending and requesting institutions, but provide no benefit to either the lending institution (other than reciprocal ILL privileges) or to publishers, who obtain no additional fees based on these interlibrary loans.

For these and other reasons, improvements are desirable.

### SUMMARY

In a first aspect, an electronic content loan system comprises a library server configured to store electronic content associated with a lending institution. The loan system further includes a user interface accessible to a requesting institution and configurable to display a listing of electronic content available on the library server, the electronic content including content for which limited-time access is available. The loan system also includes an order processing system configured to receive requests for limited-time access to the content and process payments associated with those requests.

In a second aspect, a method of allowing access to electronic content comprises receiving at a library server a request for limited-time access to electronic content from a requesting institution. The method further includes receiving payment from the requesting institution. The method also includes granting a patron affiliated with the requesting institution a limited-time access right to the electronic content from the library server. The method includes disbursing at least a portion of the payment to a publisher affiliated with the content, and disbursing at least a portion of the payment to a lending institution having access to the content.

In a third aspect, an interinstitutional loan network comprises a library server configured to store electronic content affiliated with a lending institution. The library server includes a user interface accessible to a patron associated with the requesting institution, the user interface configurable to display a listing of electronic content available for limited-time access from the lending institution. The library server further includes an order processing system configured to receive requests for limited-time access to the content.

In a fourth aspect, a library server comprises a memory configured to store electronic content and access right affiliations with a plurality of institutions. The library server further includes a programmable circuit operably connected to the memory. The programmable circuit is configured to execute program instructions to receive a request for limited-time access to electronic content from a requesting institution, and to receive payment from the requesting institution. The programmable circuit is also configured to execute program instructions to grant a patron affiliated with the requesting institution a limited-time access right to the electronic content. The programmable circuit is configured to execute program instructions to disburse at least a portion of the payment to a publisher affiliated with the content, and also disburse at least a portion of the payment to a lending institution having access to the content.

In a fifth aspect, an electronic content loan system comprises a user interface accessible to a requesting institution, the user interface configurable to display a listing of electronic content for which limited-time access is available. The electronic content loan system further includes an order processing system operable on a library server and configured to receive requests for limited-time access to the content and process payments associated with those requests. The order processing system allocates a portion of the payments to a publisher of the content.

In a sixth aspect, an electronic content loan system facilitating interinstitutional access of electronic content between a lending institution and a requesting institution comprises a library server and a payment processing server. The library server is communicatively connected to an interinstitutional loan network and configured to control access to electronic content affiliated with a lending institution in the interinstitutional loan network. The library server includes a programmable circuit configured to execute machine instructions to generate a user interface accessible to a requesting institution, the user interface configurable to display a listing of electronic content available to the library server, the electronic content including content for which limited-time access is available. The library server is also configured to receive interinstitutional loan requests from a requesting institution and provide access to the electronic content to the requesting institution from the lending institution. The payment processing server is communicatively connected to the library server and configured to process payments associated with the requests.

In a seventh aspect, a method of providing access to electronic content owned by a lending institution to a requesting institutions from among a plurality of possible requesting institutions, comprises receiving a request from a requesting institution at a library server for limited-time access to electronic content, the electronic content owned by a lending institution separate from the library server. The method comprises receiving payment from the requesting institution at a payment processing server communicatively connected to the library server. The method also comprises, in response to receiving payment from the requesting institution, granting to a patron computing system affiliated with the requesting institution a limited-time access right to the electronic content from the library server. The method further comprises disbursing at least a portion of the payment from the payment processing server to a publisher affiliated with the content, and disbursing at least a portion of the payment from the payment processing server to a lending institution having access to the content.

### BRIEF DESCRIPTION OF THE DRAWINGS

FIG. 1 is a schematic diagram of one possible embodiment of an electronic network having a system for interinstitutional loan of electronic content;

FIG. 2 is a schematic diagram of one possible local electronic network associated with a system for interinstitutional loan of electronic content;

FIG. 3 is a flowchart of methods and systems for providing interinstitutional loans;

FIG. 4 is a schematic diagram of one possible content delivery system;

FIG. 5 is a schematic diagram of another possible embodiment of a content delivery system;

FIG. 6 is a flowchart of methods and systems for loading content into a library server useable within an interinstitutional loan system;

FIG. 7 is a flowchart of methods and systems for placing an interinstitutional loan within an interinstitutional loan system;

FIG. 8 is a block diagram of an overall interinstitutional loan system;

FIG. 9 is a block diagram of a system capable of implementing an overall interinstitutional loan system;

FIG. 10 is an example search screen from an electronic content catalog useable in conjunction with an interinstitutional loan system;

FIG. 11 is an example content detail screen from an electronic content catalog useable in conjunction with an interinstitutional loan system;

FIG. 12 is an example account login screen useable in conjunction with an interinstitutional loan system;

FIG. 13 is an example shopping cart screen useable in conjunction with an interinstitutional loan system;

FIG. 14 is an example payment screen useable in conjunction with an interinstitutional loan system;

FIG. 15 is an example patron forwarding screen useable in conjunction with an interinstitutional loan system;

FIG. 16 is an example message sent to a patron of a requesting institution generated using an interinstitutional loan system;

FIG. 17 is an example message sent to an institution confirming an order placed using an interinstitutional loan system;

FIG. 18 is an example user interface for allowing access to loaned content useable in conjunction with an interinstitutional loan system;

FIG. 19 is a flowchart of methods and systems for making payment for use of an interinstitutional loan system;

FIG. 20 is a flowchart of methods and systems for allocating payment for use of an interinstitutional loan system;

FIG. 21 is an example order history file generated using an interinstitutional loan system; and

FIG. 22 is an example illustration of payment breakdowns among content providers in an interinstitutional loan system.

### DETAILED DESCRIPTION

Various embodiments of the present disclosure will be described in detail with reference to the drawings, wherein like reference numerals represent like parts and assemblies throughout the several views. Reference to various embodiments does not limit the scope of the claimed invention, which is limited only by the scope of the claims attached hereto. Additionally, any examples set forth in this specification are not intended to be limiting and merely set forth some of the many possible embodiments for the claimed invention.

In general terms, this patent document is directed to hardware, systems, and methods for an interinstitutional loan system for distributing electronic content. The interinstitutional loan system contemplated herein has technical advantages and functionality that was not possible in the traditional loan systems for sharing content. For example, it provides greater physical control over, and management of, electronic content between institutions such as libraries, publishers, individuals, and other entities that loan content.

The logical operations of the various embodiments are implemented as: (1) a sequence of computer implemented steps, operations, or procedures running on a programmable circuit within a general-use computer, (2) a sequence of computer implemented steps, operations, or procedures running on a specific-use programmable circuit; and/or (3) interconnected machine modules or program engines within the programmable circuits.

The logical operations described herein, as well as user interfaces, machine modules, and program engines described herein can be executed on one or more servers or other computing systems. Example computing systems can include those constructed by a variety of computer manufacturers, such as Apple, Dell, International Business Machines, and the like. Such computing systems can include, for example, a general purpose or specifically-designed programmable circuit and operably connected memory device, and are configured to execute program instructions to execute the operations described herein.

The programmable circuit can be, for example any of a variety of processing units available from a variety of manufacturers, for example, Intel or Advanced Micro Devices. The computing system also typically includes a system memory that couples various system components including the system memory to the processing unit. A display device can be used to display the user interfaces, as processed by the memory and programmable circuit. Other peripheral devices can be included in the computing system as well.

The computing system can operate based on instructions stored on computer storage media, communication media, or other means of encoding computer instructions. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system.

Communication media typically communicates or transports computer-readable instructions, data structures, program modules, or other data embodied in a modulated data signal, which is a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above examples of computer storage media and communications media also should be included within the scope of computer-readable media. Computer-readable media may also be referred to as computer program product.

In general, the present disclosure relates to methods and systems for providing an interinstitutional loan system for electronic content. The electronic content loaned among institutions can include electronic books, image files, digital audio files, video files, or other electronic audio/video information. The electronic content is content that is generally accessible to at least one institution, such as a library or university. The content can be “loaned” to another institution, in that a different institution can access the content for a limited time, with the permission of a lending institution and/or publisher.

In general, institutions have various types of users, such as patrons, librarians, faculty, administrative staff, and others involved in obtaining, processing, and reading or otherwise accessing content for the institution. In the present disclosure, these various roles have been summarized as a patron, faculty, and librarian role. These roles may be performed by users of a system, or by computers accessible to users. These users/computers are referred to herein as “institutional users,” indicating that each of the users is part of a common institution, such as a library or university.

The various types of institutional users contemplated by the present disclosure may be provided different access rights. Access rights refer to the collection of rights associated to a user with respect to a piece of content. For example, a patron may have read-only access to a piece of content, while a faculty member may be able to read and print that content, or a librarian may be able to include or exclude the content from the institution's collection of content altogether. Other access rights are possible as well, and depend largely upon the access control system used to enforce the content distribution controls inherent in the systems underlying the present disclosure. Furthermore, various access rights may be attributed to administrative users from an institution (e.g., librarians, other administrative users) from non-administrative users (e.g., patrons).

The access methods described herein relate generally to a tethered model of access, indicating that an entire piece of content does not get delivered to any one institutional user. Rather, the content is delivered on a portion by portion basis, such as chapter by chapter, page by page, or some other subdivision of content. Although this tethered disclosed in the exemplary embodiments of the interinstitutional loan systems, other content delivery subsystems allowing entire works to be delivered to a user may be implemented as well.

The present disclosure relates generally to content loading, accessing, and order processing of interinstitutional loans within an overall network. Illustrative networks in which the overall disclosure may be implemented are first described. Incorporation of content into the systems used for interinstitutional loans is then described. Various embodiments of interinstitutional loan requests, processing, and content access are then covered, followed by details of order processing and payment.

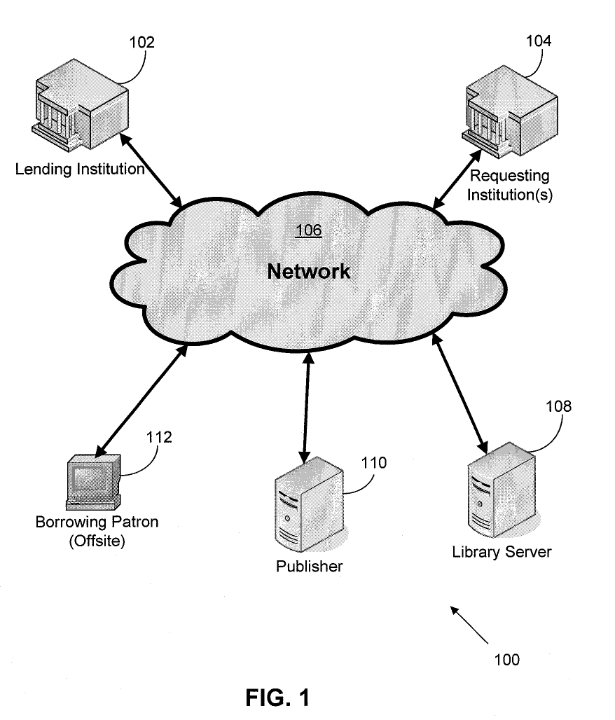

Referring now to FIG. 1, an example interinstitutional communication network 100 is depicted in which aspects of the present disclosure can be implemented. The interinstitutional communication network 100 provides a structure through which institutions, such as governments, libraries, universities, or other institutions may share information with each other, such as electronic content. The network 100 generally includes a lending institution 102 and a requesting institution 104, communicatively connected via a network 106. The lending institution 102 can be any institution that has previously agreed to provide all or part of the electronic content affiliated with that institution to another institution. The requesting institution 104 corresponds to the institution seeking access to the materials on behalf of a patron, staff, or faculty of that institution.

The network 106 represents an inter-institutional communication conduit through which electronic content can pass. The network 106 connects the lending institution 102 with the requesting institution 104, and also connects those institutions to other entities, as described in further detail herein. In various embodiments of the network 100, the network 106 can be formed from Internet connections among the institutions and the public in general.

A library server 108 is also communicatively connected to the network 106. The library server 108 provides a commonly accessible computing subsystem that can store or control access to electronic content associated or affiliated with one or more institutions. The library server 108 can receive content (or rights to content) from the institutions or other sources, and can associate each piece of content with one or more institutions. For example, an electronic book may be owned or licensed by two institutions, and not owned by a third institution. In a possible embodiment of the library server 108, the electronic book is stored once in a memory subsystem of the server, and is associated with identifiers or those two institutions that own the book. In a further embodiment, the electronic book is referenced in memory of the library server 108 as being stored at the institutions. When one of those two institutions requests access to the stored electronic book, the library server 108 can allow access to that book, from local memory or from the institution. When the third institution requests access to the book, that third institution is denied access to the book, because it is not affiliated with the book.

The library server 108 also can store and manage account information and various usage rights for the institutions associated with the library server. The library server 108 can allow a different access privileges to institutions accessing the server, such as allowing a different number of users from each institution to connect to any given piece of content or to the content affiliated with that institution overall. Other different access privileges are possible as well. The library server 108 also can provide different authentication methods for connection to content for each institution, such as username/password authentication, IP address-based authentication, or other forms of authentication. Other features integrable into a library server, including interinstitutional loans, are described in further detail herein.

In certain embodiments, the library server 108 is controlled by an institution, and controls access to only the content related to that institution. In further embodiments, the library server 108 controls access to content related to multiple institutions, and can be located at one or more locations (e.g., in the instance of a distributed computing system).

A publisher 110 also is optionally communicatively connected to the network system 106. The publisher 110 represents a source of electronic content, and is analogous to the publisher of printed content in that it refers to the entity holding the capability of granting or denying permission to access of the electronic content. Generally, the publisher 110 is the copyright holder of the electronic content held on the library server 108 or at one or more of the institutions 102, 104. The publisher 110 can refer, in various contexts, to the publishing entity itself, an employee of the publishing entity, or a computing system owned by the publishing entity.

A patron 112 is shown as connected to the network 106. The patron 112 represents a patron of one or both of the lending institution 102 and the requesting institution 104, and depicts a patron not within a local network of that institution 102 or 104. The patron 112 represents a remote user who is a patron of an institution or is otherwise affiliated with the institution (e.g., is a librarian or faculty of the institution). The patron 112 can connect to the network 100, and therefore to their associated institution (e.g., institutions 102 or 104, respectively) and to the library server 108, allowing the patron to (1) be associated with their respective institution as understood by the library server 108; and (2) access electronic content on the library server 108 in association with access rights equivalently to the access rights of those individuals at the institution 102 or 104 with which the patron 112 is affiliated.

In certain embodiments, differing user rights are available to remote patrons (e.g., patron 112) as opposed to patrons within the trusted network of an institution associated with the library server 108. Other implementations are possible as well. Furthermore, in certain aspects, the network 100 is a portion of the Internet connecting the various institution types described herein.

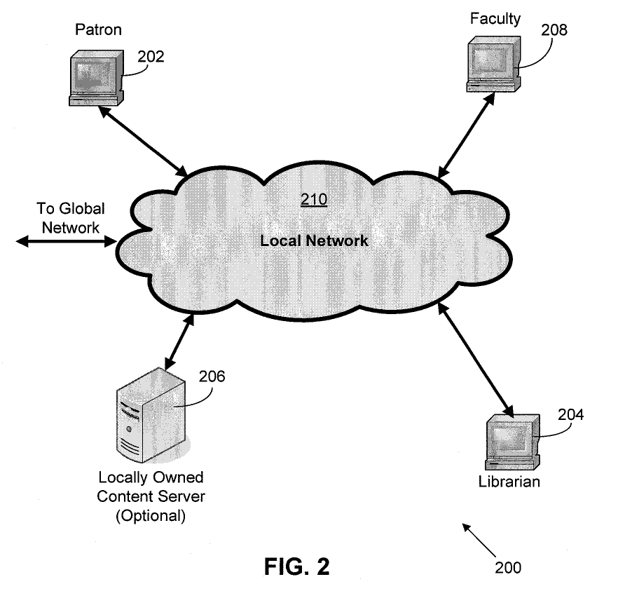

FIG. 2 is a schematic diagram of a local content distribution network 200 associated with an institution 102 or 104 within which aspects of an interinstitutional loan system can be implemented. The local content distribution network 200 can represent a communication network within one or both of the lending institution 102 or requesting institution 104, or other interim networks within the network 106 of FIG. 1. The local content distribution network 200 can include a patron 202, a librarian 204, a local content server 206, and faculty member 208. Other individuals with other content access roles may exist within the network 200 as well.

The patron 202 represents a person associated with the institution, or a computing system accessible to such a person having access privileges granted to it based on an understanding that the person using the computing system is associated with the institution. The patron 202 generally is a source of requests for electronic content, and is provided electronic content in association with the access privileges granted to it by the institution. In certain embodiments, the patron 202 is locally situated, in that the patron accesses electronic content while located within the institution or within the network control of the institution. For example, the patron can use a computing system placed within a library or within a building of a university to access electronic content. In certain other embodiments, the patron is remotely located, and can access electronic content of an institution with which they are affiliated by use of a username and password or other authentication.

The librarian 204 is an administrative user of the network 200 in at least certain aspects, in that the librarian can include or exclude patrons from access to electronic content affiliated with the institution, and can perform various other functions with respect to the content affiliated with that institution. The librarian 204 can refer to either an administrative user/employee managing content of an institution or can refer to an administrative role in a computing system managing electronic records and/or content within an institution. The librarian can add or remove electronic content from the local content server 206, and can affiliate content with the institution in general, such as by purchasing content or access rights to content. The librarian can have additional administrative rights and roles within the institution, and generally can perform the variety of institutional administration tasks involved in use of the interinstitutional electronic content loans system of the present disclosure.

The local content server 206 stores local electronic content for the institution. In certain embodiments, the local content server 206 is not present, and the institution entirely uses an external content server to that institution, such as the library server 108 of FIG. 1. Other embodiments are possible as well in which the local content server 206 is present in conjunction with an external server, and various rules and access privileges may be employed for the librarians 204, patrons 202, and faculty members 208 of the institution to receive content from one or both systems.

The faculty member 208 represents another patron of the institution, similar to the patron 202, but may be granted a different level of access privileges to content affiliated with the institution. For example, the faculty member 208 may have additional rights with respect to accessing certain content affiliated with the institution 102 or 104, or may have a longer or otherwise different loan period during which the faculty member 208 has access to content. Other rights are possible for the faculty member 208 as well. For example, because faculty members 208 will generally change less frequently than patrons 202, the faculty members 208 associated with an institution may be granted unique access rights to content, as opposed to a generalized patron access right afforded to patrons 202. In a further example, in certain embodiments the faculty member 208 does not require preapproval of a librarian or other administrative entity of the institution to initiate an interinstitutional electronic content loan. Other variations regarding access rights of content are possible as well.

The patron 202, librarian 204, local content server 206, and faculty member 208 are communicatively interconnected by a local network 210 in existence within the relevant institution. The local network can represent a local area network, wide area network, or other Internet/network connection that consists of an affiliated portion of the network. By affiliated, it is intended that the various entities have access to a common set of electronic content and are logically associated (e.g., the patrons are students at a university represented by the institution, which has faculty, etc.). The various persons/computer access levels available on the network 200 may have access to different subsets of the overall set of electronic content, which may be stored locally (e.g., on the local content server) or on a remote computer such as the library server 108 of FIG. 1.

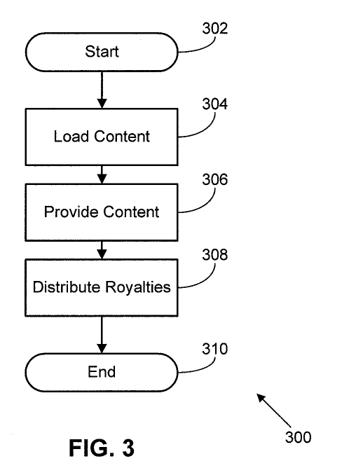

FIGS. 3-5 illustrate various systems that can provide interinstitutional loans for electronic content, according to various aspects of the present disclosure. The systems and methods described herein may be implemented using the various networks and components of FIGS. 1-2, respectively, and can provide delivery of electronic content among institutions that are affiliated with that content and institutions which are not normally affiliated with the content. The systems described herein provide a temporary affiliation between content and an institution which is generally not affiliated with that content, allowing one or more patrons of the unaffiliated institution access to the content.

Referring now to FIG. 3, a flowchart of methods and systems for providing interinstitutional loans is shown. The system 300 provides certain overall processes which occur within an interinstitutional loans system to provide electronic content to users of the system, and can be executed using hardware and software systems such as those shown in FIGS. 1-2. The system 300 is instantiated at a start operation 302, which initializes a system for interinstitutional loaning of electronic content. The start operation 302 can include actions such as associating one or more institutions with a library server 108 configured to store electronic content accessible to those institutions. Other operations may be incorporated into the start operation as well.

Operational flow within the system 300 proceeds from the start operation to a load operation 304. The load operation 304 loads electronic content into a repository for access by the institutions. In a possible embodiment, the load operation 304 loads electronic content into a library server, such as is shown in FIG. 1, or in a local content server such as is shown in FIG. 2. The load operation 304, in general, receives electronic content at a computing system, formats the electronic content for the selected delivery methodology of the content delivery system in use by the institutions planning to access the content, and stores that content such that it can be accessed by an institutional user.

The load operation 304 associates the content loaded with the publisher from which the content was originally received, to allow the system 300 to (1) verify that the publisher allows interinstitutional loans, and (2) to optionally allocate some portion of an interinstitutional loan payment to the publisher as an incentive to allow such loans to take place. Other reasons for associating the publisher during storage of content can exist as well.

In a possible embodiment, the load operation 304 segments and stores the content such that it can be used in a tethered content delivery system. In a further embodiment, the load operation 304 affiliates the content with one or more institutions, such as those institutions which provided the content or provided some indication that they have a right to access the content. Other operations are possible as well, such as are described herein.

Operational flow proceeds to a content access operation 306. The content access operation 306 receives a request to access one or more pieces of content stored during operation of the load operation 304. The content access operation 306 verifies that the content is held within the computing system upon which system 300 operates, and outputs at least a portion of the content to the user. In the embodiments described herein, the content access operation 306 determines that the content is affiliated with the institution from which the request is received prior to providing some of the content to that requesting institution. In the various embodiments of the interinstitutional loan system described herein, this requires (1) a determination that the content is not affiliated with the requesting institution, (2) a determination that the content is available to the system 300, and (3) order processing to temporarily affiliate the content with the requesting institution. This can occur, for example, by identifying an institution with which the content is already affiliated, and requesting access to that content from that “lending” institution. When permission is received from the lending institution (whether or not the content is actually stored at the lending institution), access is granted to the requesting institution, on a limited time basis, to the content. Additional operations may be incorporated into the content access operation 306 as well. Specific details of an example embodiment of a content access operation are described herein.

Operational flow proceeds to a payment operation 308. The payment operation 308 receives payment from a requesting institution related to some content managed using the system 300 that is otherwise unaffiliated with that requesting institution. The payment operation 308 apportions the payment received from the requesting institution to one or more interested parties having access to the content, including the lending institution, a publisher of the content, and the entity administering the system 300. Other entities are possible as well. Furthermore, additional operations may be incorporated into the payment operation 308 as well.

Operational flow terminates at an end operation 310. The end operation 310 completes the initial interinstitutional loan operation. The end operation 310 can include expiry of the limited-duration access right to content by a requesting party, thereby preventing later access attempts relating to that content, in that it is again unaffiliated with the requesting party. In such instances, a subsequent interinstitutional loan process or a purchase of a permanent access right to the content would allow the requesting party the right to subsequent access of the content.

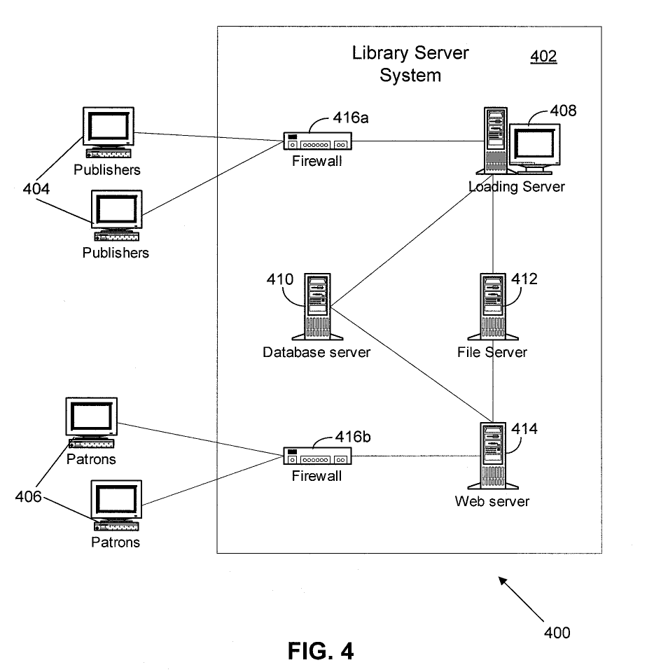

FIG. 4 is a schematic diagram of a content delivery system 400. The content delivery system 400 represents portions of the overall system of FIG. 1, and illustrates the data flow allowing content loading and delivery. The system 400 includes a library server subsystem 402 interconnected to a plurality of publishers 404 and patrons 406.

The library server 402 generally provides a centralized location for loading and/or accessing electronic content, such as electronic books. The library server 402 connects to the publishers and patrons 406 by communicative connections, such as the network connections described above in conjunction with FIG. 1. The publishers 404 correspond generally to the publisher 110 referenced in FIG. 1, and generally are content-providing entities which allow the library server to store and manage access to the content received from each publisher. The patrons 406 correspond generally to the various institutions (e.g., institution 104) and patrons (e.g., offsite patron 112 or patrons at the institution 104) of FIGS. 1-2, and represent possible users who would request access to content on the library server 402 as received from the publishers.

The library server 402 includes a loading server 408, a database server 410, a file server 412, and a web server 414. Other servers may be incorporated into the library server 402 as well. The loading server 408 receives content from the publishers 406 or other institutions, and processes that data for storage in or reference by the library server 402. The loading server 408 can perform a number of actions on the content, such as: receiving content; conforming the content to a tethered content delivery model by subdividing the content by page or section; assigning various catalog attributes to the overall content and its subdivisions; generating various metadata describing the content received, and loading the content and associated metadata and catalog attributes into one or more of the other databases.

The loading server 408 also includes a user interface presented to publishers 404 which allows the publishers to upload content to the library server 402. In further embodiments, the user interface allows institutions to upload content under their control to the library server 402. The user interface allows the publishers 404 or institutions to control access privileges to the content affiliated with each of the institutions and/or publishers.

The database server 410 stores an indexed version of content, allowing the library server 402 to respond to full-text searches of electronic content. The database server can include a content parsing module (which could alternatively reside on the loading server 408 or the file server 412) which parses the content as it is received by the library server 402, thereby indexing and storing keywords into a database usable by patrons or other users searching the content of the library server.

The file server 412 stores the content processed by the loading server 408, and is accessed based on user selections, such as after the user views their text-based search results received from the database server 410. The web server 414 provides an access methodology for patrons or other users to access the content stored within the library server 402. The web server 414 communicates the list of content available to a patron (i.e. the content affiliated with the institution with which the patron is associated). The web server 414 generates pages allowing the patron and other institutional users to view listings of content available to those specific institutional users, select content to view, and display that content to those users. In a possible embodiment, the web server 414 uses a standardized web server platform, such as Internet Information Services software provided by Microsoft Corporation of Redmond, Wash., or an open source web server software package for providing a display interface to the patrons 402.

One or more firewalls 416a-b can optionally be incorporated into the library server 402 to regulate access to the various servers 408-412 incorporated within, to prevent unauthorized access, tampering, or corruption of the servers and content stored thereon. The firewalls 416a-b can act to, for example, allow only communication with trusted entities at the web server 414 and the loading server 408. Other implementations of firewalls are possible as well.

Overall, the system 400 is described as being hosted on four specific types of servers having predefined roles to perform the tasks required of the library server 402. However, in other embodiments, more or fewer physical computing systems may be employed, and the specific roles and functionalities of those servers may differ from the specific roles as described relating to the library server 402. For example, the library server 402 can correspond to an access control mechanism that centrally manages access to content of one institution, based on requests by users affiliated with other institutions. In such embodiments, the library server 402 can be unaffiliated with all institutions, in that it provides a clearing house for access to content while allowing each institution to manage and store its own content.

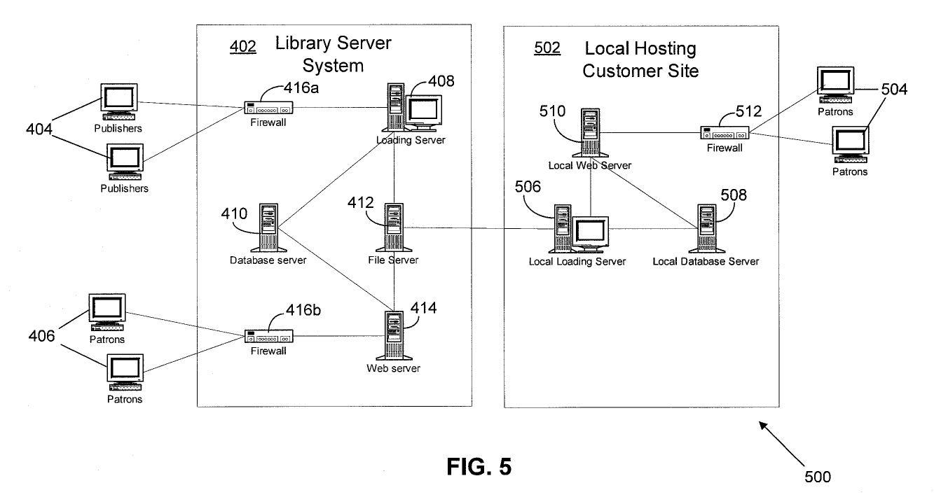

FIG. 5 is a schematic diagram of a content delivery system 500. The content delivery system 500 generally corresponds to the content delivery system 400 of FIG. 4, but allows for local storage of content at one or more institutions affiliated with the content, as previously mentioned as an embodiment of FIG. 4. Specifically, the content delivery system 500 includes analogous components to the system 400, but also includes a local content server 502 configured to connect to additional patrons 504. The local content server 502 generally provides patrons 504 of an institution local access to content without requiring a long internet connection sequence to occur, thereby eliminating a large amount of latency in receiving the requested content. Generally the patrons 504 requesting content from the local content server 502 will be in an area nearby the local content server 502, such that communication with the computing system holding the content (in this case the local content server 502) is quicker.

In the embodiment shown, the local content server 502 includes a local loading server 506, a local database server 508, and a local web server 510. The local loading server 506 is communicatively interconnected with the file server 412 of the library server 402. The local loading server 506 obtains the content from the file server 412, and performs processing steps for the content affiliated with the institution. The processing steps performed by the local loading server 506 will generally be a subset of the tasks performed by the loading server 408 of the library server 402, in that the local loading server acts on the pre-segmented and pre-processed content of the file server 412. The local loading server 506 generates a local set of metadata and catalog information associated with the content affiliated with the institution.

A local database server 508 stores a local set of keyword data for searching for content among the content affiliated with the institution. The local database server 508 is interconnected with the local loading server 506, and receives index keywords and metadata describing the content on the file server 412. As compared to the database server 410, the local database server 508 generally holds a smaller keyword indexed database, based only on the affiliated content as opposed to all of the content on the library server 402. The local web server 510 provides a locally-hosted interface for patrons 504 and other institutional users associated with the local content server 502 to search, access, and view the content affiliated with the institution. The local web server 510 is interconnected with the local database server 508 and the local loading server 506 to receive both listings and content (through the local loading server 506 and from the file server 412). The local web server 510 can, in various embodiments, provide an analogous user interface to the web server 414, but will only display search results and/or catalog listings of content available to the local web server and affiliated with the institution. A local firewall 512 provides local security for the local library server 502, analogous to the firewalls 416a-b.

The arranged systems of FIGS. 4-5 show only a few of the possible arrangements of systems within the networks of FIGS. 1-2 for providing interinstitutional loans of electronic content. Various other arrangements of computing systems and logical procedures may be possible as well depending upon the computing demands placed on those systems by publishers, patrons, and other institutional users.

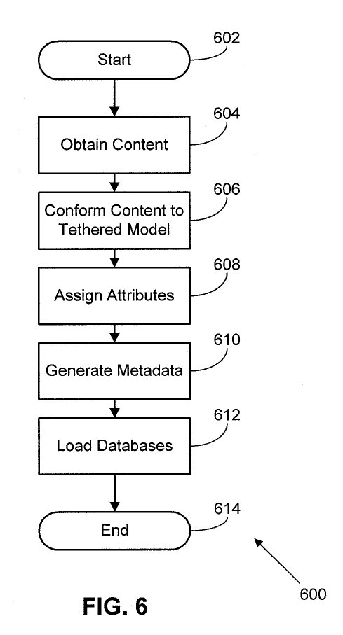

Prior to allowing users to view content or perform interinstitutional loans, electronic content is generally loaded onto a computer system, such as the file servers and/or database servers described in FIGS. 4-5. FIG. 6 illustrates a flowchart of a possible embodiment of methods and systems for loading content into a library server useable within an interinstitutional loan system. The system 600 as illustrated provides the basic steps generally performed in loading content; however based on the specific implementation of the interinstitutional loan system employed, more or fewer processing and content loading steps may be included.

In various embodiments of the system, many of the operations within the system 600 are performed using a loading or preprocessing computer system, such as the loading server 408 of FIG. 4. Other computer systems may be used to execute the system 600 as well.

Operational flow within the system 600 is instantiated at a start operation 602, which corresponds to receipt of an indication that the system is to receive electronic content to load into a database useable for interinstitutional loans. Operational flow proceeds to an obtain content operation 604, which corresponds to receipt of the raw content. The content can take any of a number of forms, but is generally electronic content or has the capability of being transformed into electronic content. For example, the content may be received in a wide variety of file formats, such as Microsoft Word, Excel, WordPerfect, Adobe PDF, JPG, TIFF, HTML, or other formats. In further embodiments, the content may be received as printed content from a publisher, but may be able to be scanned into an electronic document format, such as one of the formats listed. The obtain content operation 604 generally determines the format of the received content and verifies that the content is of a form that can be processed by the rest of the system 600.

Operational flow proceeds to a conformance operation 606. The conformance operation 606 conforms the content, once received and, if necessary, converted to electronic form, to a format consistent with the method in which that content will be delivered to a user. In the embodiment shown, the conformance operation 606 conforms the content to a tethered content model, in that the content is split into a number of separate electronic files, each file representing a subsection of the overall content. In one embodiment, the conformance operation 606 separates the content on a page-by-page basis; in other embodiments, different subdivisions (chapter, section, etc.) may be used.

Operational flow proceeds to an attributes operation 608. The attributes operation 608 determines attributes of the piece of content as a whole, as well as attributes for each subdivision. For example, the attributes operation 608 can determine a title, author, publisher, publishing date, ISBN number, subject, classification, and other information about the content as a whole. The attributes operation 608 also can determine an ordering among the subdivided portions of the content, as well as the order of display of the portions. Each of the portions can then be assigned a set of attributes, including attributes common to all portions of the electronic content and attributes specific to the subdivided portions of content.

Operational flow proceeds to a metadata operation 610. The metadata operation 610 extracts metadata from the content which describes the content. The metadata operation 610 receives the attribute information, and also receives additional information relating to the content as received from the publisher. For example, the metadata can include the information contained in a Machine-Readable Cataloging (MARC) record, which may be received from a publisher, or may be added to by the system 600 or a user of the system.

Operational flow proceeds to a database loading operation 612. The database loading operation 612 loads the extracted and generated information, as well as the processed content, into one or more databases or file structures on computing systems configured to store and provide access to that content. Using the example system of FIG. 4, the database loading operation 612 will load the metadata into the database server, and load the processed and segmented files into the file server.

One or more of the operation 608-612 also performs a text parsing operation that crawls across the content as it is examined for the various other procedures described herein, and extracts keywords from that content. The keywords extracted from the content are placed into a database alongside the metadata for that content (e.g. in the database server 410 of FIG. 4) to allow full-text searching capabilities with respect to the content.

Operational flow terminates at an end operation 614, which indicates completed loading of at least one piece of electronic content into a computing system for use within an interinstitutional loan system.

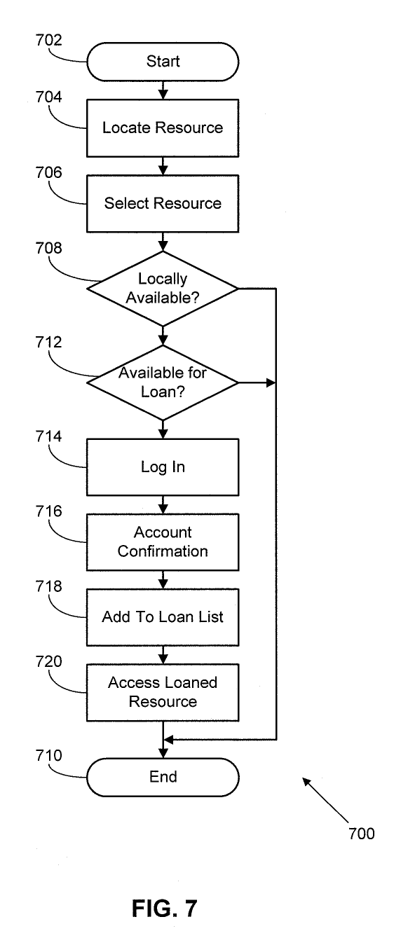

FIGS. 7-19 illustrate methods, systems, and user interfaces useable in a particular embodiment of the interinstitutional loan system for electronic content. The methods, systems, and user interfaces disclosed can form a portion of an ordering system, such as a system resident on a library server or some other type of server within one of the networks previously described. FIG. 7 is a generalized flowchart of methods and systems for placing an interinstitutional loan within an interinstitutional loan system. The methods and systems disclosed contemplate interaction with a user, such as a patron of an institution, who desires access to a piece of content which may or may not be normally affiliated with that institution. The present disclosure provides procedures by which the content not normally affiliated with a patron's institution can be affiliated with that institution for a limited time, providing the patron or other institutional user with a limited time access right to the content.

In various embodiments of the system, many of the operations within the system 700 are performed using a computing system included in a library server, such as the library server 402 of FIG. 4 or server 108 of FIG. 1. Other computer systems may be used to execute the system 700 as well.

The system 700 of FIG. 7 is instantiated at a start operation 702, which corresponds to receipt of a request for a particular resource. The start operation 702 may incorporate any of a number of user-interaction operations, such as displaying a search screen and receiving a query relating to a subject, title, keyword, or other content identifier. Operational flow proceeds to a location operation 704, which locates matching resources to the received search parameter. A resource selection operation 706 receives a user's selection of a resource, and identifies metadata relating to the content as well as the content itself.

Operational flow proceeds to an affiliation operation 708, which determines whether the selected content is affiliated with the institution with which the patron/user is associated. If the content is affiliated with the institution, the patron or other institutional user has access to that content and therefore operational flow branches “yes” to an end operation 710. The end operation 710 signifies that a decision is made to either grant or deny access to the requested content for the requesting patron. In this case, the end operation 710 signifies granted access to the content.

If the content is not affiliated with the institution, the patron or other institutional user does not by default have access to that content. In such a case, operational flow branches “no” to a loan availability operation 712. The loan availability operation 712 determines whether the content that is requested is available to be loaned, and whether the patron or other institutional user wishes to obtain such an interinstitutional loan of the content. The loan is referred to as an interinstitutional loan in that the content which the patron desires is stored and affiliated with an institution which the patron is not associated with, but the content is not affiliated with the patron's institution. The loan availability operation 712 specifically determines whether there exists an institution which (1) is affiliated with the content and (2) has indicated that it would give permission to loan the content (e.g. a lending institution). If either the content is not available or the user does not wish to borrow the content, operational flow branches “no” to the end operation 710, signifying denied access to the content for that patron.

If the content is available to be loaned and the patron would like to borrow the content, operational flow branches “yes” to a login operation 714. The login operation 714 requests an institutional user's credentials, to verify that the institutional user has the permission of his/her institution to request an interinstitutional loan. Institutions preferably have previously registered with the interinstitutional loan process manager, and have indicated that certain users have the ability to request such loans. For example, a university may grant the ability to complete such a loan to a librarian at the university library, and also to faculty of the university, but would not grant the ability to complete a loan to a student or general patron of the university library. The login operation 714 verifies that the user is one of the preapproved users, or denies access to the content. In one embodiment, the login operation 714 denies access to patrons of institutions unaffiliated with the content, but refers the patron to a librarian or another party having the right to request an interinstitutional loan to allow that authorized user to perform the process 700.

Operational flow proceeds to an account confirmation operation 716. The account confirmation operation 716 confirms that the logged in user has a preexisting interlibrary loan account. The account confirmation operation 716 accesses the account of the logged in institutional user, and verifies that payment information has been entered for that institution. For example, a librarian can log in to request an interinstitutional loan of an electronic book. If that librarian has not created an account including credit card or invoice information, the account confirmation operation 716 will present a screen to that user requesting the required information. If the librarian has created such an account, the account and payment information is then linked by the account confirmation operation 716 to the requested content.

Operational flow proceeds to a loan listing operation 718. The loan listing operation 718 adds the requested content to the account of the user who requests the loan of this content. The loan listing operation 718 tracks the time the loan was made to determine the elapsed time during which the content will be accessible to the requesting user. In one embodiment, the loan listing operation 718 displays a user interface including a list of all of the loaned content and the period for which each piece of content is accessible to institutional users (e.g. the amount of time remaining for the limited-time access right affiliating the content with the institution related to the user). In a second embodiment, the loan listing operation 718 sends a message to a designated user, such as a user denoted by the librarian ordering the loan. The message can be configured to provide a link through which the content can be accessed. Additional information can be displayed as well, either in the user interface or within the message.

Operational flow proceeds to a loan content access operation 720. The loan content access operation 720 receives a request to access the content, such as from a requesting user clicking on a link (either in a webpage user interface or within the body of an email message, for example) with embedded security and identification parameters. The loan content access operation 720 verifies the authentication credentials embedded in the link and generates a user interface displaying the requested content. The loan content access operation 720 displays the electronic content after confirming that the user is within the limited time of the limited time access right granted to them.

Operational flow proceeds from the loan content access operation 720 to the end operation 710, which corresponds with completed access of the interinstitutional loaned electronic content.

Within the system 700, additional operations and notifications are possible for notifying or interacting with an institutional user. In various embodiments, portions of the system 700 are configured to interact with an administrative user, such as a librarian, while other portions of the system are configured to interact with a user seeking access to content, such as a patron. Differing combinations of access rights and usage rights are possible within the system.

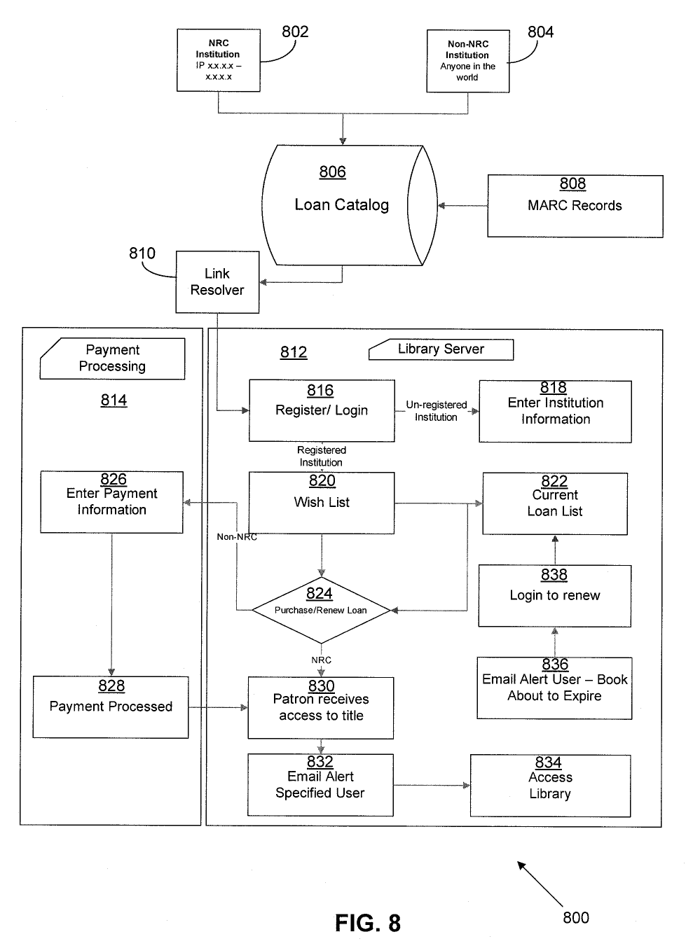

Referring now to FIG. 8, a functional block diagram of an example interinstitutional loan system 800 is shown. The system 800 illustrates process flow for interinstitutional loans made among various types of institutions, including certain types of research institutions which are allowed to access content without payment of royalties. In the example shown, institutions supported by the National Research Council (Canada) generally will not be required to pay royalties for such interinstitutional loans. Other institutions may be treated similarly, and would follow the “NRC institution” institution process flow of the system 800.

In the system 800 as shown, both an NRC-type institution 802 and a generalized (paying) institution 804 can access a loan catalog 806. The loan catalog stores records of available electronic content. The loan catalog 806 may reside within a library server (such as those shown in FIGS. 4-5) or may reside external to the library server (as shown in FIG. 8). The loan catalog 806 receives records of content held and available to loan to the various institutions 802, 804. In the embodiment shown, the loan catalog 806 receives Machine-Readable Cataloging (MARC) records 808, from which the loan catalog is built. The institutions 802, 804 view the various MARC records of the content available to that institution, either by affiliation with that institution or by availability of an interinstitutional loan to the institution. An institutional user browsing the catalog 806 selects a particular piece of content which is unaffiliated with the institution, triggering instantiation of the interinstitutional loan process.

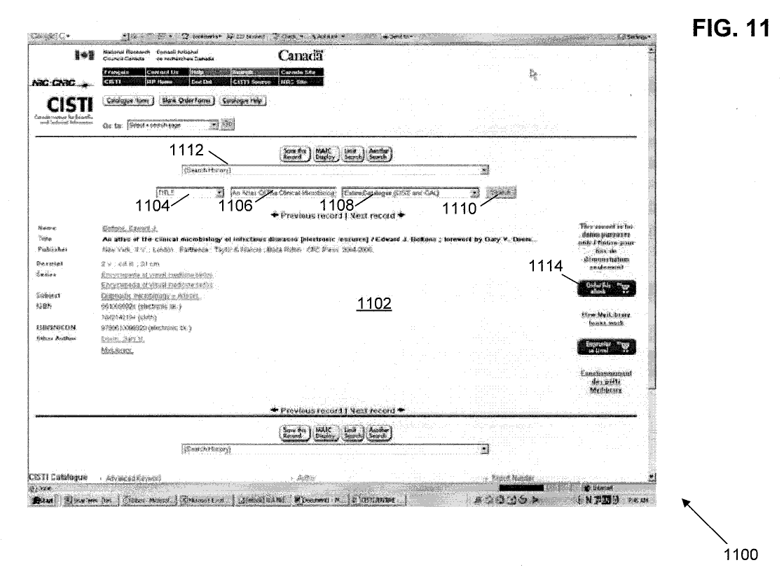

In one embodiment, the loan catalog 806 resides on one or more servers managed by the institution. In a further embodiment, the loan catalog resides on one or more servers managed by the managing entity of the interlibrary loan process. An example user interface generated from browsing the loan catalog is shown in FIG. 11.

A link resolver 810 redirects links from the loan catalog to a library server 812 to retrieve content. In one embodiment, the link resolver 810 resolves all links to the library server, including links to content affiliated with the institution. In a further embodiment, the link resolver only resolves links to the library server which are to be processed through an interlibrary loan system. Other embodiments are possible as well. Furthermore, in embodiments where the catalog resides on the library server 812, the link resolver 810 is excludable from the system 800.

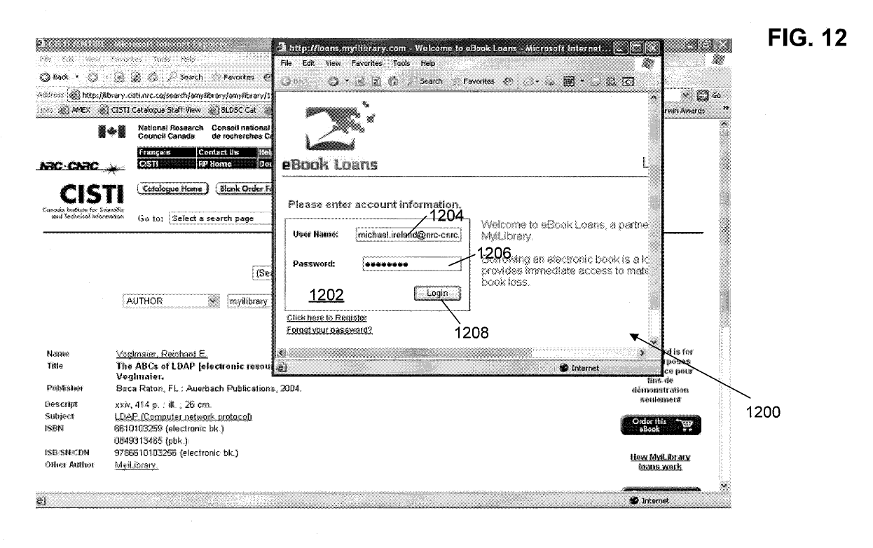

The library server 812 generally provides the content access and interinstitutional loan capabilities of the system 800. The library server 812 resides alongside a payment processing system 814 which generally manages incoming payments from institutional users to access content using an interinstitutional loan. In alternative embodiments, the library server 812 and payment processing system 814 reside on a common computing system or otherwise share computing resources. The library server 812 receives the redirected link connections from the link resolver 810 and routes users to a login process 816. The login process 816 displays a login user interface, and determines from the login credentials whether the institution from which the loan request came is a registered institution or an unregistered institution. One example login user interface is shown in FIG. 12.

If the link is received from an institutional user who is from an unregistered institution, operational flow proceeds to an institutional information gathering process 818. The information gathering process requests various information from the institution, such as the name of the institution, usernames and passwords of patrons, librarians, and other institutional users, information about content affiliated with the institution, payment information, and other information. If the link is received from a user who is from a registered institution, operational flow proceeds to a wish list process 820. The wish list process 820 displays a user interface including the wish list associated with an institution. The contents and methods of updating the wish list may vary. For example, various patrons from an institution may be able to add content to the wish list, while only librarians from the institution may accept and process those wish list entries into interinstitutional loans. Other methods by which loans are processed and communicated are possible as well.

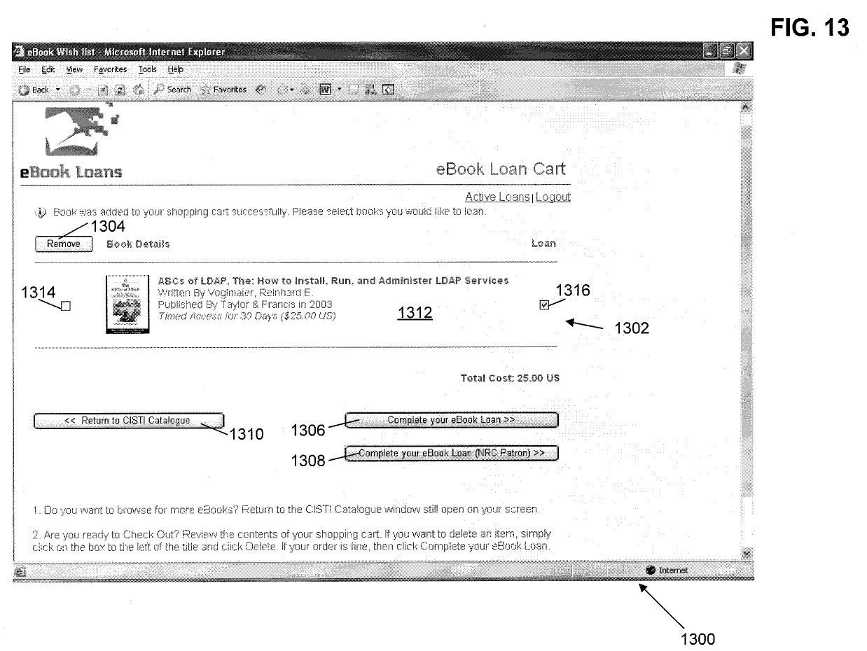

From the wish list process 820, operational flow can proceed to either a current loan process 822 or a purchase loan operation 824, depending on user selection of one or both options in the user interface generated alongside the wishlist. The current loan process 822 displays a user interface which includes a list of currently-loaned materials available to the library on a limited-duration access right basis. The user interface can display a variety of information about the various pieces of electronic content available to a user of the system 800 based on the limited-duration access right, such as the title, author, cover page, and time remaining in the loan period. The user interface also can include buttons associated with each piece of content allowing the user to click on the button to renew the loan of each piece of content, causing operational flow to proceed to the purchase loan operation 824. Other information can be displayed as well. An example of such a user interface is displayed in conjunction with FIG. 13.

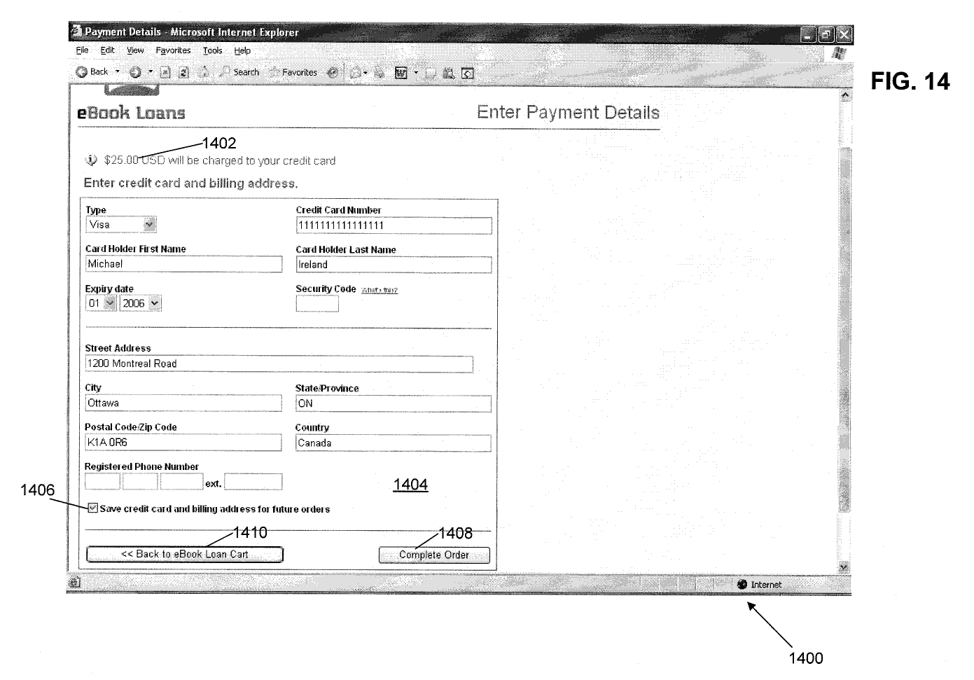

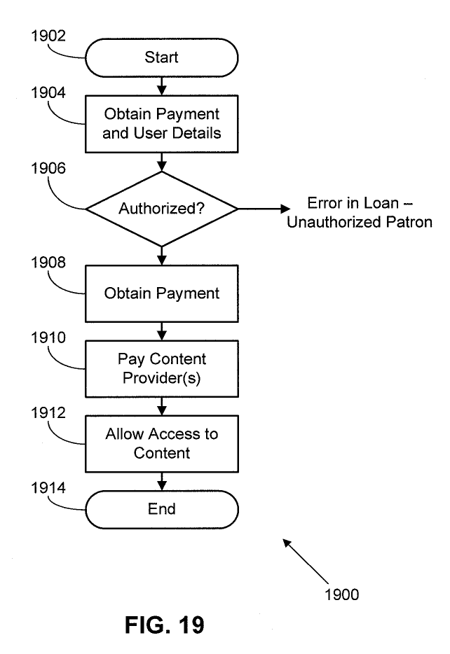

The purchase loan operation 824 is accessed through buttons on user interfaces generated by the wish list process 820 or the current loan process 822. The purchase loan operation 824 determines whether the institutional user who is obtaining the loan is from an institution that is required to pay for the loaned materials. For example, if the institution is a National Research Council institution, it may not be required to pay for loaned materials that are affiliated with other National Research Council institutions. If the institution must pay for the interinstitutional loan, operational flow proceeds to a payment information process 826 that is part of the payment processing system 814. The payment information process 826 displays a user interface requesting payment information on behalf of the institution, such as the one shown in FIG. 14. The user interface can include a number of fields to be filled in by the user, such as the user's name, the institution's name, method of payment, payment information, and other information. Operational flow proceeds from the payment information process 826 to a payment registration process 828. The payment registration process 828 validates the information obtained in the payment information process 826, and charges the institution a fee to borrow the electronic content requested. Additional details regarding the various processes available via the payment processing system 814 are described in greater detail in conjunction with FIGS. 19-22.

Operational flow proceeds to an access process 830, which activates access to the requested content for the limited duration period. The access process 830 enables access to a particular piece of content by temporarily affiliating that content with the requesting institution. The access process 830 can, for example, add the content or an identifier of the content to a list, such as the list displayed by the current loan process 822.

If the institution does not need to pay for the interinstitutional loan (e.g. is an NRC-type institution), operational flow proceeds directly to the access process 830, and the same actions are performed by the process without charging the institution for the temporary access right to the electronic content.

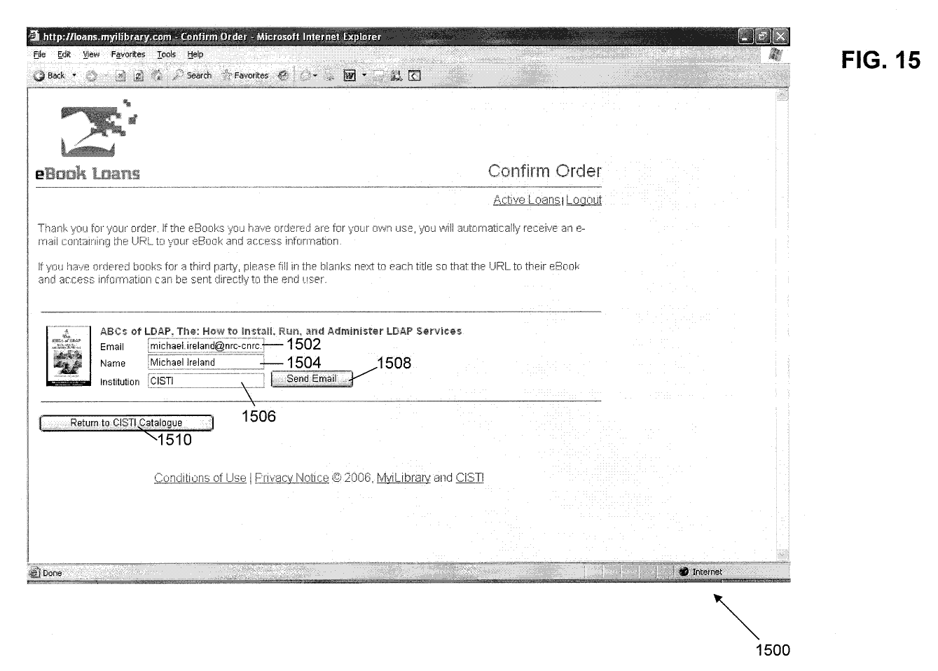

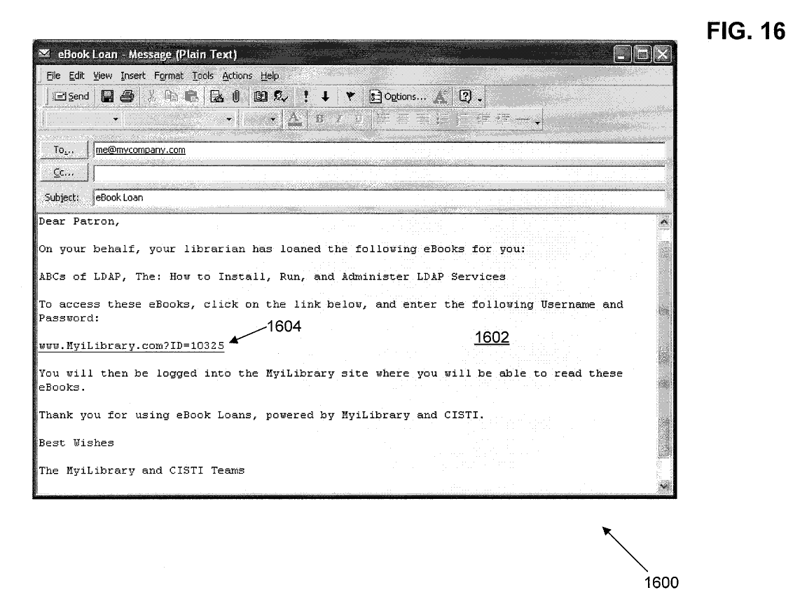

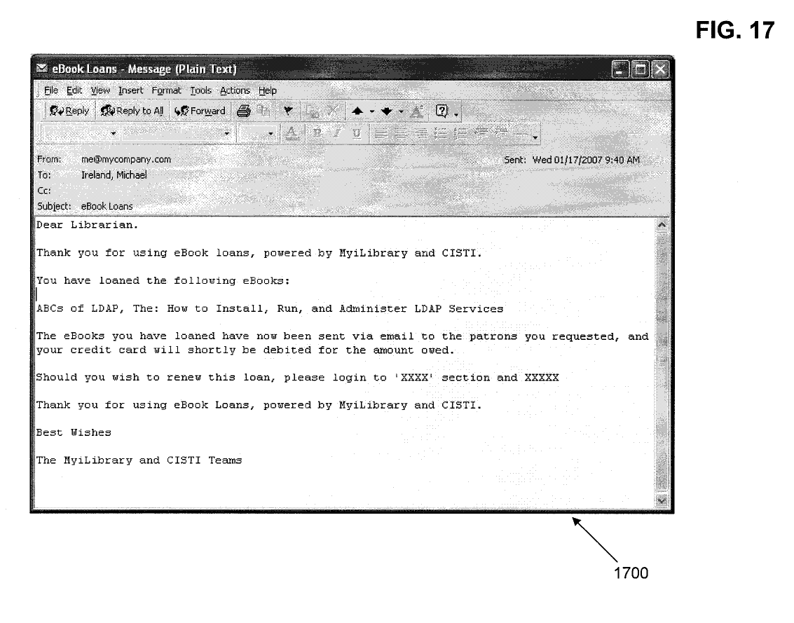

Operational flow proceeds from the access process 830 to a notification process 832. The notification process notifies a patron of the fact that the authorized institutional user (e.g. a librarian) has completed ordering a loan for electronic content, and that the content is now available for access. In certain embodiments, a user interface is generated that allows a user to enter one or more email addresses to which a notification will be sent regarding the availability of the borrowed content. An example user interface for generating notification messages is shown in FIG. 15. In certain embodiments, the notification process 832 generates an email message to the patron who initially requested access to the electronic content, to the administrative institutional user who ordered the loaned content, or to both. In such embodiments, the email messages can notify these users of the status of the loan, and can optionally contain an hypertext link with embedded credentials to allow direct connection to the content. Example messages are displayed in FIGS. 16-17.

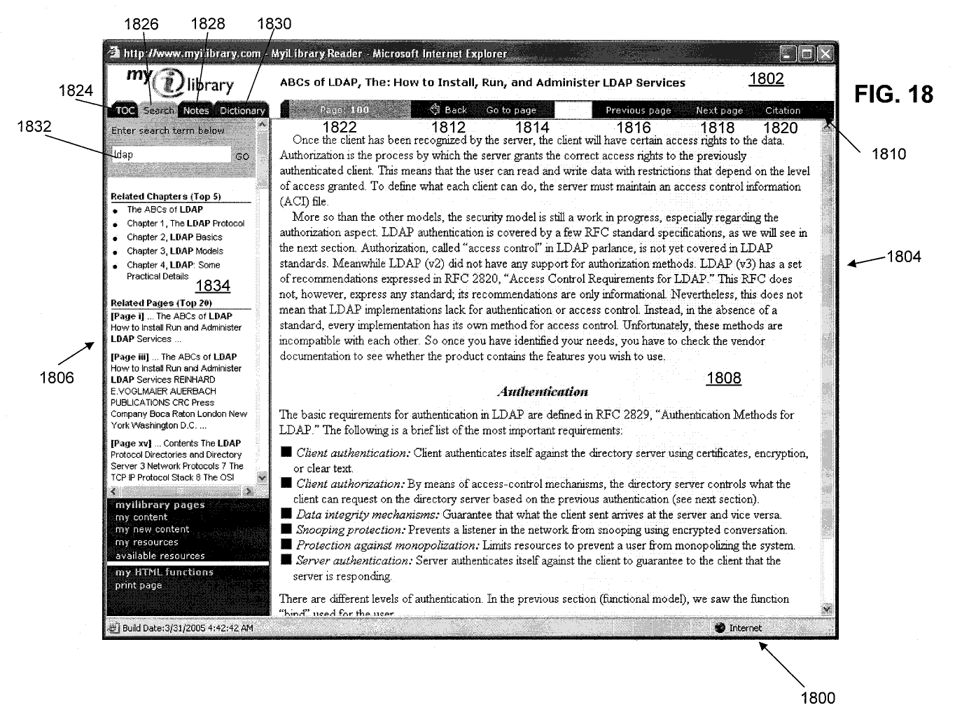

Based on user-selection of the link in the message or otherwise sending to the library server a request for access to the content, operational flow proceeds to a content display process 834. The content display process 834 displays the content to the requesting institutional user, after receiving proper credentials (such as through the embedded credentials in the hypertext link generated and sent by the notification process 832). In the embodiment shown, the content display process 834 conforms to a “tethered” model of content access, allowing the institutional user to perform periodic accesses of content held by a library server or local library server to access an entire piece of electronic content, such as on a page-by-page, section-by-section, chapter-by-chapter, or some other basis. Each page is loaded and displayed in a user interface presented to the user, with navigation controls included within the user interface. One possible user interface is shown in FIG. 18.

Through operation of the display process 834, an institutional user, such as the patron, faculty or librarian requesting the limited time access right to electronic content can view the content hosted in a browser window or some other type user interface for a tethered access model. The institutional user can exit the browser window or other user interface, and can return to view or use the content a subsequent time, so long as that subsequent time occurs within the limited duration of the loan period.

After expiration of the time period of the loan, a user from the institution temporarily affiliated with that content will no longer be able to access that content. This can occur, for example, by the library server 814 removing that content from the current loan list managed by the current loan process 822, preventing the user from gaining access to the content on the library server or affiliated with an institution with which that user is not affiliated. To prevent sudden loss of such rights, a renewal alert process 836 can send a message to an institutional user such as the requesting patron or librarian of the requesting patron's institution. The message can indicate impending expiration of the limited duration access right for certain content. The message can be sent to the institutional user or librarian by email or other method, and can include an embedded link to connect that institutional user to the library server to renew that content.

If the institutional user clicks on a link within the message sent to that person, operational flow within the system proceeds to a renewal login process 838. The renewal login process generally corresponds to the login process 816. The renewal login process optionally has different access permissions than the login process 816, in that more or fewer institutional users may act to renew an interinstitutional loan than can initially request such a loan. In one embodiment, faculty and librarians are allowed to log in to the library server 812 to initiate a loan, but any patron can renew that same loan once it is made. In further embodiments, rights to login and initiate and renew loans are coextensive.

Operational flow proceeds from the renewal login process 838 to the current loan process 822. By entering the current loan process 822 by way of the renewal login process, the user logging in is not associated with any particular identified new electronic content to loan (as opposed to entering from the loan catalog 806 via the link resolver 810, which will pass the identity of certain new content to the library server 812 to initiate an interinstitutional loan). This allows a user viewing the user interface of the current loan process 822 to only renew existing content, rather than adding additional content to the list of currently loaned content.

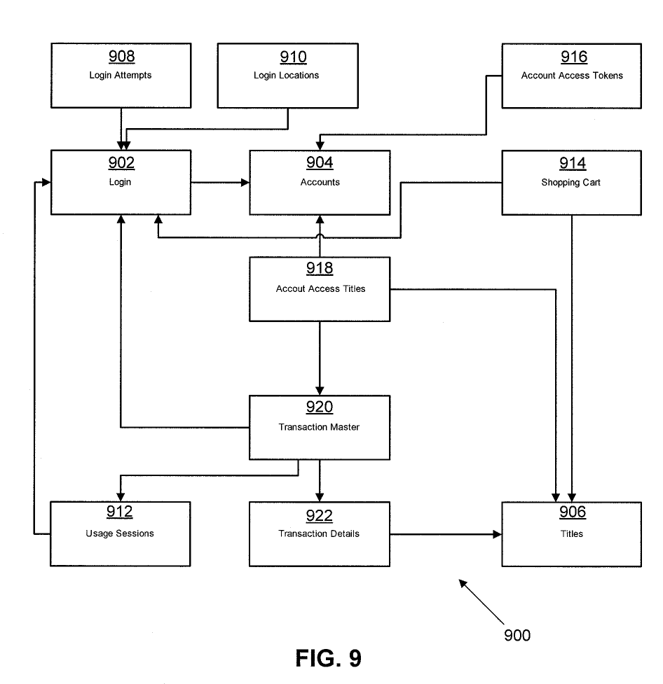

Referring now to FIG. 9, a block diagram of a data management schema 900 managed by the library server 812 is shown, such that the library server can manage content, institutional accounts, user interface generation, account transactions, payments, and other types of transactions. The schema 900 illustrates the data relationships tracked by the library server regarding affiliations among content, institutions, accounts, payments, and various other transaction details. The various tables illustrated herein may be implemented in a number of ways within a variety of different types of database management systems, and can be combined or separated for ease of use in various alternative embodiments of the schema 900.

Within the schema 900, the main tables are accessed to allow a patron to read content managed by the library server, including a login table 902, an account table 904, and a title table 906. The login table 902 stores records regarding users logging into the library server. Example records can include the username and password used to log in, the date and time of logging in, the IP address of the computer used to log in, and other information. The account table 904 is linked to the login table 902, and stores a listing of active accounts allowed to access content on the library server. In various embodiments, the account table 904 can include names and identifiers of institutions, as well as references to specific information about that institution, such as the authorized institutional users able to request an interinstitutional loan, the currently borrowed content, wait list content, contact information, payment information, and other information.

The title table 906 can hold the full list of titles available on the library server, as well as any metadata associated with those titles. In certain embodiments, the various titles in the title table 906 are linked to the accounts in the account table 904, thereby affiliating certain titles with each institution. By linking a subset of the entire list of titles with an account of an institution, that institution can be provided, by default, access to a subset of the entire library of content held on the library server. One embodiment of the system links, for a limited time, requested content from the title table 906 to an account of a requesting institution in the account table 904, to provide a limited duration access right to that content for the requesting institution.

The schema 900 also includes an account login attempts table 908 and an account login locations table 910. The account login attempts table 908 and an account login locations table 910 are linked to the login table 902, and track additional transactions related to users and non-users attempting to login to access content on the library server. The account login attempts table 908 logs all attempted logins detected by the library server. The account login attempts table 908 tracks both successful and unsuccessful login attempts. The account login locations operation 910 tracks the locations from which login attempts are received. The account login locations operation 910 can store, for example, IP addresses from which login attempts were received, as well as known domain names, routing information, or other information providing insight into the source of the login attempt.

A session table 912 and shopping cart table 914 are both also linked to the login table 902, and relate to transactions performed by an administrative institutional user in ordering interinstitutional loans of content. The session table 912 holds specific details of each connection session in which an institutional user connects to the library server. Example details contained in the session table 912 can include the duration of a session, pages and content viewed, number of pages or pieces of content viewed, time viewing each piece of content or page, and other information. The shopping cart table 914 can contain links to content which are selected by the user but have not yet been purchased. For example, the shopping cart table can include the wish list items associated with an institution, or additional items such as records of content purchased.

A tokens table 916 and an accessed titles table 918 are both linked to the account table 904, and each relate to accesses of various content. The tokens table 916 stores a record of web tokens provided to a user's computer for accessing content. The accessed titles table 918 maintains a list of instances in which the library server is accessed and content is provided. The accessed titles table 918 is further linked to the titles table 906, and relates those titles to the account to provide a history of titles accessed by the various institutions managed in the accounts table 904.

A transaction table 920 and a transaction details table 922 track commercial transactions, including purchases of content and purchases of interlibrary loans of content. The transaction table 920 is linked to the accessed titles table 918, as well as to the login table 902 and the session table 910. The transaction table 920 provides an indication to these tables as to the specific transaction which have taken place during a session, such as number of titles or other pieces of content accessed, and other information. The transaction details table 922 tracks specific page accesses and stores detailed information about the accesses of the content on the library server. The transaction details table is linked to from the transaction table 920, and in turn links to the titles table 906.

It is understood that more or fewer tables could be implemented in the schema 900 of FIG. 9 to track and manage access to content on the library server. For example, various additional tables regarding user preferences, advertisements, and other information could be included and linked to various titles and accounts based on user histories. Other features may be incorporated into the schema as well.

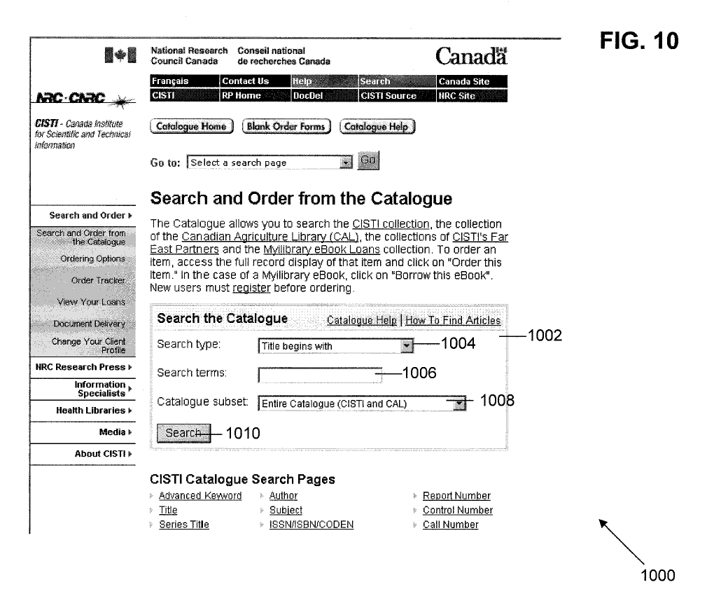

Referring now to FIGS. 10-18, various user interface screens are displayed which illustrate an example interinstitutional loan and content access process according to a possible embodiment. These figures provide only a sample of user interfaces generated by the systems and processes of the present disclosure; various alternative user interface designs, functionality ordering, and processes can be used as well, and can be generated by one or more of the systems described herein.

FIG. 10 illustrates an example search screen 1000 from an electronic content catalog useable in conjunction with the interinstitutional loan systems described herein. The example search screen 1000 represents a possible screen generated using the locate content operation 704 described in conjunction with FIG. 7, or to view the catalog 806 described in conjunction with FIG. 8. The screen 1000 provides a user interface allowing institutional users, such as patrons or librarians, to identify electronic content held either by the institution or remote from the institution which can be accessed through a computing system, such as a remotely-managed library server. The screen 1000 includes a search criteria box 1002 which includes a search type drop-down menu 1004, a term field 1006, a catalog subset drop-down menu 1008, and a search button 1010. The search type drop down menu 1004 provides a list of selectable criteria for which to search using the term field 1006. A user will generally type one or more keywords into the term field and optionally narrow that search using the search type drop down menu 1004 to specify whether the keywords must be found in the title, subject, abstract, or other portion of the electronic content. The catalog subset drop-down menu 1008 allows the search to be narrowed further, based on a segmentable portion of the catalog. For example, the catalog may be segmented into various content blocks, such as loanable content, locally-managed content, nonfiction content, reference materials, or any other type of content subdivision. The search button 1010 causes the search currently entered into the fields 1004-1008 to be executed, and causes the system to proceed to display a listing of search results.

Additional searching criteria and functionality may be included in the screen 1000, based on the information tracked regarding the various content in a catalog of available electronic content. For example, the search criteria box 1002 could include additional fields relating to subject-area searching, locally-hosted content searching, or other search criteria not selected using the various criteria outlined herein.

FIG. 11 illustrates an example content detail screen 1100 from an electronic content catalog useable in conjunction with the interinstitutional loan systems described herein. The content detail screen 1100 represents a further possible screen generated using the locate content operation 704 described in conjunction with FIG. 7, or to view the catalog 806 described in conjunction with FIG. 8, to browse for and select content. The content detail screen 1100 displays detailed information about selected content located using the search screen 1000 of FIG. 10. In the embodiment shown, the content detail screen includes a content description region 1102, a search type drop-down menu 1104, a term field 1106, a catalog subset drop-down menu 1108, a search button 1110, as well as a search history drop down box 1112. The content description region 1102 includes the various information relating to the selected piece of content, such as the name, title, publisher, description, subject, ISBN number, author, and other MARC record information. The search type drop-down menu 1104, term field 1106, catalog subset drop-down menu 1108, and search button 1110 provide analogous functionality to that described in conjunction with FIG. 10. The search history drop down box 1112 allows a user to select past searches or search results, allowing the user to view the results of those searches.

Additionally, a loan link button 1114 allows a user to select the content associated with the displayed information for an interinstitutional loan request. The loan link button 1114 connects a user into an interinstitutional loans system, such as through use of a redirecting link referring the user to a library server. In one embodiment, the loan link button 1114 can connect the user through use of a link resolver, such as the link resolver 810 of FIG. 8.

FIG. 12 is an example account login screen 1200. The account login screen 1200 includes an account login region 1202, which in turn includes a username field 1204, a password field 1206, and a login button 1208. A user can enter their username or email address into the username field 1204, as well as a predetermined password into the password field 1206. When the user subsequently clicks on the login button 1208, the username and password information is sent to the library server, which validates that the user is associated with a particular institution and validates that the user is allowed to initiate loans of electronic content (e.g. the user is a librarian or other administrative user associated with the institution).

Additional information can be displayed on the account login screen as well, including global messages from the library server to various institutional users, or other information regarding the status of the requested content. Other information may be displayed as well. Furthermore, the account login screen 1200 can, in various embodiments, be generated by a login process of a library server, such as the login process 816 of FIG. 8.

FIG. 13 is an example shopping cart screen 1300 which displays one or more pending interinstitutional loans. The shopping cart screen 1300 can be generated and presented to an institutional user by, for example, a library server performing a wish list process or purchase operation, such as are disclosed in conjunction with FIG. 8. The shopping cart screen 1300 can be displayed to the user after a piece of electronic content is selected and the user logs into the interinstitutional loans system on a library server, by use of a login screen such as the screen 1200 of FIG. 12.

The shopping cart screen 1300 includes one or more content display regions 1302, as well as a remove button 1304, a loan completion button 1306, a nonprofit loan completion button 1308, and a return button 1310.

The content display regions 1302 display various details of a piece of electronic content selected to be requested for an interinstitutional loan by an administrative user. The content display regions 1302 include a description region 1312, a remove check box 1314 and a loan check box 1316. The description region includes details about the content to be requested, and optionally also includes a picture of the cover of the book. The remove check box 1314 allows the user to select the piece of content to remove it from the shopping cart using the remove button 1304. The loan check box 1316 allows the user to select the piece of content to complete the loan request for that content using one of the loan completion button 1306 and the nonprofit loan completion button 1308.

The return button 1310 allows the user to return to browsing through the catalog records displayed in other user interfaces, such as the screens displayed in FIGS. 10-11.

Other buttons may be included on the shopping cart screen 1300, such as buttons corresponding to adding variable amounts of time to an electronic content loan, or to various other alternatives relating to borrowing electronic content via a library server.

FIG. 14 is an example payment screen 1400 useable in conjunction with the interinstitutional loan systems described herein. The payment screen can be generated and presented to an institutional user by, for example, a library server performing any of a number of payment-related processes, such as are disclosed in conjunction with FIG. 8. The payment screen 1400 can be displayed to the user who clicks on and selects to borrow one or more pieces of electronic content displayed in a shopping cart screen, such as the screen 1300 of FIG. 13. The payment screen 1400 includes a payment display region 1402 and a payment information entry region 1404. The payment display region displays details of a payment to be made to complete the interinstitutional loan. In the embodiment shown, the payment display region 1402 includes the amount of money to be paid to complete the loan; in other embodiments, additional information about the method of payment, the content requested, and other information may be included as well.

The payment information entry region 1404 includes a plurality of user-entry fields allowing a user to enter sufficient information to pay for an interinstitutional loan via credit card, including the type of card, credit card number, cardholder name, expiration date, security code, address, and other information. The payment information entry region also includes a save information check box 1406, which allows the library server generating the screen 1400 to store the payment information, and a complete order button 1408, which registers the information as completed and triggers an order processing operation by the library server, as described in FIG. 8. An optional back button 1410 returns the user to a shopping cart or wish list screen, such as the screen shown in FIG. 13.

FIG. 15 is an example patron forwarding screen 1500 useable in conjunction with the interinstitutional loan systems described herein. The patron forwarding screen 1500 allows the user to enter one or more user names and email addresses, so that the library server can send email messages to those users indicating that the requested content is available for viewing during a newly-activated loan period. The patron forwarding screen 1500 includes an email field 1502, a name field 1504, an institution field 1506, and a send button 1508. The email field 1502 received user-entered email addresses to whom notifications of the newly-borrowed content can be sent. The name field 1504 receives a name associated with the email address of the email field 1502, such that the name of the user can be displayed in the subsequent email to that user (see, e.g., FIG. 16). The institution field 1506 receives information relating to the institution for which the content is borrowed, which also can be incorporated into the message to the user identified by the other fields 1502, 1504. The send button 1508 confirms the information in the fields 1502-1506, and generates a message to send to the identified user. The screen 1500 also includes a return button 1510. The return button 1510 allows the user to return to browsing through the catalog records displayed in other user interfaces, such as the screens displayed in FIGS. 10-11.

FIG. 16 is an example message sent to a patron of a requesting institution generated using the interinstitutional loan systems described herein. The institutional user typically receiving a message 1600 will be a patron or other non-administrative user who previously requested a loan of the content from the librarian or other administrative user at the institution. The message 1600 can be generated, for example, based on entry of a user's email address into a user interface by an administrative user (e.g. a librarian requesting a loan of the electronic content on behalf of the non-administrative user). Although the content of the message 1600 can vary, the message 1600 can include a description of the content 1602 and an embedded link 1604. The description of content 1602 can be a listing of the borrowed title, or can include additional information describing the content available for review by the recipient of the message. The embedded link 1604 is generally a hypertext link connecting the user to a user interface displaying the loaned content (e.g. as shown in FIG. 18). In some embodiments, the embedded link 1604 includes embedded credential information, such that the user receiving the message 1600 does not need to enter a username and password. In other embodiments, the embedded link 1604 does not include credential information, and that information may or may not be required for accessing content.

FIG. 17 is an example message sent to an administrative institutional user confirming an order placed using the interinstitutional loan systems described herein. The message 1700 can be generated, for example, based on the email address of the person logged into the library server using the login process of FIG. 8. The administrative institutional user typically receiving a message 1700 will be a librarian, faculty, or other user having usage rights allowing them to incur interinstitutional loan charges on behalf of the institution. Although the content of the message 1700 can vary, it will generally confirm that the interinstitutional loan is active, and that users from the requesting institution have access to the content. The message 1700 generally displays the title of the content, as well as instructions relating to renewal and other usage instructions.

FIG. 18 is an example content access screen 1800 for allowing access to loaned content useable in conjunction with the interinstitutional loan systems described herein. The content access screen 1800 allows institutional users to view content on a computer communicatively connected to a library server holding the content. The content access screen 1800 provides the tethered access to content by allowing segmented access to the content on a page-by-page, section-by-section, or other segmented basis.

The content access screen 1800 includes a title bar 1802, content region 1804, and a navigation sidebar 1806. The title bar 1802 displays the title of the electronic content currently being displayed. The content region 1804 generally includes a content display region 1808 and a menu bar 1810. The content display region 1808 displays the text of the content requested to be displayed, typically on a page-by-page basis. The pages can be displayed in any of a number of formats including a standard web format, such as HTML, or in a standardized read-only document format such as a Adobe's Portable Document Format (PDF). Other formats are possible as well, and can be used for a variety of different types of content, such as a plain text format, Microsoft Word format, various video formats (MPEG-4, WAV, etc.), or formats useable for other types of electronic content.

The menu bar 1810 displays a plurality of buttons useable to browse through the electronic content. In the embodiment shown, the menu bar 1810 includes a back button 1812, a goto field 1814, a previous page button 1816, a next page button 1818, and a citation button 1820. The back button 1812 allows the user to go to a previously viewed page of the content. The goto field 1814 allows the user to enter a page or section number and browse directly to that page. The previous page button 1816 and next page button 1818 allow for forward and reverse browsing through the pages of the document. The citation button 1820 causes a popup screen or other display to appear, showing one or more standardized citation formats for the currently displayed content. A current page indicator 1822 displays the current page being displayed of the electronic content. Other buttons, fields, and commands with respect to the document may be included as well.

The navigation sidebar 1806 generally includes peripheral commands for searching through the content and for allowing additional customized uses of the content. The various tabs of the navigation sidebar 1806 are user-selectable, and the sidebar displays different options based on which tab is the currently-active tab. The sidebar 1806 as shown includes a table of contents tab 1824, a search tab 1826, a notes tab 1828, and a dictionary tab 1830. The table of contents tab 1824 displays a linked outline of the overall document. A user can select one of the sections of the outline by clicking on the section, causing the screen 1800 to display the first page of that section in the content display region 1808. The search tab 1826 (the active tab shown) includes a search field 1832 and a search results region 1834. The search field allows keyword searching of the text of the currently-displayed electronic content, and the results are displayed in the search results region 1834. In a possible embodiment, the search results in the search results region 1834 are user-selectable, and can be used to navigate directly to the page on which the search result appears. Other embodiments are possible as well.

In various embodiments, the content displayed in the table of contents tab 1824 and/or the search tab 1826 are drawn from metadata describing the electronic content, such as can be stored in a portion of a library server as described in conjunction with FIGS. 4-6.

The notes tab 1828 allows a user to type notes into a field that can be associated with that user's account and also with the content, such that when the same user views the content subsequently, that user's notes will be visible to him/her. In certain embodiments, the notes are related to the content as a whole; in still other embodiments, the notes tab 1828 allows the user to associate different sets of notes with each page/section displayed to that user. Other configurations are possible as well.

The dictionary tab 1830 provides a link to a third-party managed dictionary, such as are available via the internet. In certain embodiments, the dictionary tab 1830 includes a field in which the user can type an unfamiliar word (such as a word appearing in the content display region 1808) to view definitions of that word. In further embodiments, the dictionary tab responds to a user clicking on a word in the content display region 1808, and displays definitions related to that word in the dictionary tab.

The arrangement of the various components of the content access screen 1800 may vary across different embodiments. For example, the content region 1804 and navigation sidebar 1806 can be rearranged in position, and features could be moved between the two regions. Other arrangements of the screen 1800 are possible as well, including additional/fewer tabs or content display arrangements than the embodiments described herein.

In various embodiments, the user interface screens of FIGS. 10-18 can be managed and displayed by a library server 108. In further embodiments, the user interface screens can be managed by individual institutions that in turn transmit information about interinstitutional content access to the library server. The library server 108 then manages access controls to that content.

Referring now to FIGS. 19-22, various methods and systems for processing payment from institutions for interinstitutional loans of electronic content are shown. In the methods and systems of these figures, payment is allocated among a variety of institutions, such as the institution affiliated with content and agreeing to loan that content, publishers associated with content, and managers of electronic content. FIG. 19 is a flowchart of methods and systems for making payment for use of an interinstitutional loan system. The system 1900 of FIG. 19 illustrates a general payment process according to an exemplary embodiment. The system 1900 generally occurs within a payment processing system managed by the same entity managing the electronic content, such as through use of a payment processing system and a library server as described in conjunction with FIG. 8. The system 1900 generally operates in an instance where an institution that is not exempt from payment for interinstitutional loans (i.e. an institution noted as a “non-NRC institution” in FIG. 8) requests access to content from a provider of interinstitutional loan content.

The system 1900 is instantiated at a start operation 1902, which generally receives a request for electronic content by an institutional user with administrative privileges (i.e. can incur expenses on behalf of the institution for requesting loans of electronic content). Operational flow proceeds to a payment operation 1904. The payment operation 1904 displays a user interface and requests payment details from an institution. The payment operation 1904 receives payment details from the institution for processing within the system 1900. Operational flow proceeds to an authorization operation 1906, which verifies that the user seeking to complete a transaction to request an interinstitutional loan is in fact qualified to do so. Qualified individuals that may request an interinstitutional loan can include administrative institutional users, such as librarians or faculty of an institution. In certain instances, non-administrative institutional users may be included among the authorized users as well. If the user is not an authorized user, operational flow aborts, in that the system 1900 will not allow such a user to complete a payment for electronic content. If the user is an authorized user, operational flow proceeds to an obtain payment operation 1908, which obtains payment from the user by using the information collected during execution of the payment operation 1904.

Operational flow proceeds to a provider payment operation 1910, pays a content provider for making electronic content available to the requesting institution. The content provider can be any of a number of entities, including: an institution affiliated with the requested content and having a right to loan that content; a publisher providing the electronic content; and/or a manager of a library server which delivers the electronic content to the requesting party. Other entities can be incorporated within the meaning of a content provider as well. Furthermore, more than one such entity can be included within the meaning of the term content provider, with the payment operation 1910 apportioning payment among the various content providers.

Operational flow proceeds to an access operation 1912, which enables access to the content for the requesting institution, as described herein. Operational flow terminates at an end operation 1914, which corresponds with completed payment and completed allowance of access to content within the system 1900.

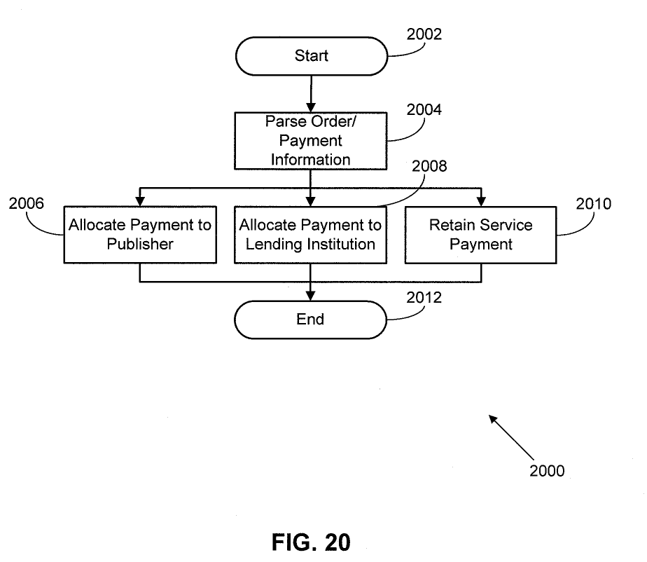

FIG. 20 is a flowchart of methods and systems for allocating payment for use of an interinstitutional loan system. The system 2000 illustrates a possible method by which a payment system can allocate money paid for an interinstitutional loan to be apportioned among various content providers. Operational flow within the system 2000 is instantiated at a start operation 2002, which receives payment for an interinstitutional loan. Operational flow proceeds to an order log operation 2004, which parses a record of an order to identify the one or more content providers associated with that order.

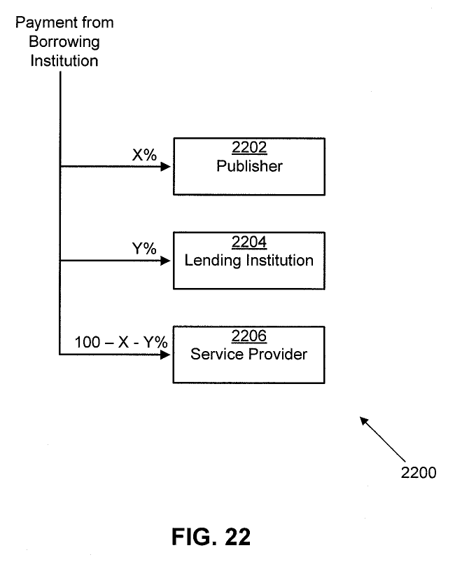

Operational flow proceeds to a plurality of payment allocation operations, including a publisher payment operation 2006, a lending institution payment operation 2008, and a payment retention operation 2010. The operations 2006-2010 apportion the payment received from the requesting institution among the various content providers, according to a predetermined formula. An example of such apportionment is described in conjunction with FIG. 22. Operational flow proceeds to an end operation 2012, which corresponds to completion of payment allocations within the system 2000.

Other operation may be incorporated into the system 2000 as well, as would be included in conjunction with other content providers. Furthermore, alternative methodologies for identifying content providers could be incorporated beyond parsing order logs, order history information, or metadata related to the such as by linking specific content with content providers (thereby eliminating the necessity for record or metadata parsing).

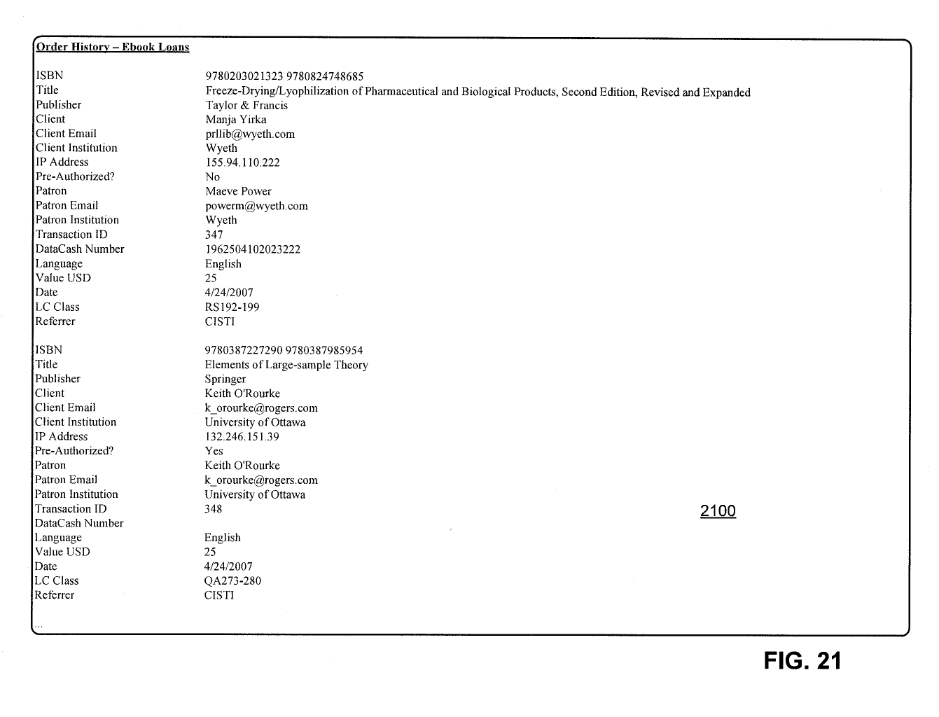

FIG. 21 illustrates an example order history file 2100 generated using an interinstitutional loan system. The order history file includes a plurality of entries 2102, each entry representing an interinstitutional loan which has successfully been processed. Each entry 2102 includes a variety of information about the content provider, requesting institution, requesting institutional user, referring (lending) institution, payment and transaction. Other information can be included in the order history file as well.

FIG. 22 is an example flowchart 2200 of payment breakdowns among interested parties in an interinstitutional loan system. The flowchart illustrates a payment allocation among a publisher 2202, a lending institution 2204, and a service provider 2206. The publisher 2202 refers to an entity provider the electronic content and having all basic rights to control distribution of that content. The lending institution 2204 refers to an institution that is affiliated with the content and allows a link from an online catalog associated with its content to direct users from other institutions to an interinstitutional loan system. The service provider 2206 refers to an entity that stores and manages access to the content, such as by providing connections to a library server which allows tethered access to content. In the flowchart 2200, it is assumed that the overall payment for each institutional loan is fully apportioned among the three entities 2202-2206; however, more or fewer entities could be allocated payment.

In the embodiment shown, the publisher 2202 is allocated X% of the overall payment received with respect to a single interinstitutional loan transaction. Likewise, the lending institution 2204 is allocated Y% of the overall payment, and the service provider receives the remainder of the payment. The “X” and “Y” stand for unrelated percentages of the overall payment that are prenegotiated among the various parties 2202-2206 to the transaction.

In various additional embodiments, the payment percentages and payment breakdown may vary based on other variables, such as volume of referrals, volume of loans related to each publisher, or loan processing loads which would cause a possible need to create a graduated scale of percentage payments as incentives change.

As is apparent from the above description of the servers, processes, and user interfaces, the user interfaces of FIGS. 10-18 present to a user data records as stored or accessed by the computing systems described herein, such as the library server and related payment processing server. Likewise, these user interfaces present the results of processes as described herein. For example, the shopping cart screen 1300, particularly the content display regions 1302, display content records selected from a loan catalog (e.g., catalog 806 of FIG. 8), and tracks such contents in a shopping cart table 914 of FIG. 9. The records in the loan catalog can be updated by linking additional data to the content records, such as loan history information (e.g. associating a requesting institution with the content for a period of time), as illustrated in tables 916, 918. Usage of loaned content can be linked to a user transaction record and other user records (e.g. a user login screen), also as shown in FIG. 9. Additionally, the order history file of FIG. 21 can be associated with a user or institution record in a database stored on a database server such as database server 410 of a library server system (e.g., as shown in FIGS. 4-5).

This linking process as used in the systems described herein, and particularly with respect to the database schema 900 of FIG. 9, can occur either by addition of information to a content record, or modifying another record linked to the content record, or modifying the link from the content record to reference an additional external record to associate the content with a requesting institution. Once a loan expires, this association or additional data can be removed from the schema 900, particularly the accessed titles table 918. Information association provided by the library server and database records stored thereon enables the loan catalog to act as a central clearinghouse for interinstitutional loans, and allows for fast fulfillment of such loans to requesting institutions, providing improved loan access to electronic content.

The various embodiments described herein are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. An electronic content loan system comprising:
a library server configured to control access to electronic content affiliated with a lending institution;
a user interface accessible to a requesting institution, the user interface configurable to display a listing of electronic content available to the library server, the electronic content including content for which limited-time access is available;
an order processing system configured to receive requests for limited-time access to the content and process payments associated with those requests.

2. The system of claim 1, wherein the order processing system allocates a portion of the payments to a publisher of the content.

3. The system of claim 1, wherein the order processing system allocates a portion of the payments to the lending institution.

4. The system of claim 1, wherein the library server is unaffiliated with the lending institution.

5. The system of claim 1, wherein the library server includes a database configured to support full text searching of the content affiliated with the lending institution.

6. The system of claim 1, wherein the library server further includes a web server configured to display a catalog of descriptions of electronic content.

7. The system of claim 1, wherein the user interface is displayed on a computing system of a patron of the requesting institution.

8. The system of claim 1, wherein the order processing system is further configured to validate that the requests are made by an administrative institutional user.

9. The system of claim 1, wherein the library server is further configured to allow limited-time access to content in response to the received requests for users affiliated with the requesting institution.

10. The system of claim 1, wherein the electronic content is stored on the library server.

11. A method of allowing access to electronic content, the method comprising:
receiving a request at a library server for limited-time access to electronic content from a requesting institution;
receiving payment from the requesting institution;
granting a patron affiliated with the requesting institution a limited-time access right to the electronic content from the library server;
disbursing at least a portion of the payment to a publisher affiliated with the content; and
disbursing at least a portion of the payment to a lending institution having access to the content.

12. The method of claim 11, further comprising retaining a remaining portion of the payment.

13. The method of claim 11, further comprising receiving account information from the requesting institution.

14. The method of claim 11, wherein granting a patron affiliated with the requesting institution a limited-time access right to the electronic content comprises granting the limited-time access right to one patron.

15. The method of claim 11, wherein granting a patron affiliated with the requesting institution a limited-time access right to the electronic content comprises granting the limited-time access right to one patron at a time.

16. The method of claim 11, wherein the request for limited-time access to electronic content includes an identifier of the electronic content and a time period for the access right.

17. An interinstitutional loan network comprising:
a library server configured to store electronic content affiliated with a lending institution, the library server including:
a user interface accessible to a patron associated with the requesting institution, the user interface configurable to display a listing of electronic content available for limited-time access from the lending institution; and
an order processing system configured to receive requests for limited-time access to the content.

18. The interinstitutional loan network of claim 17, further comprising a payment server configured to process payments associated with the requests for limited-time access to the content.

19. The interinstitutional loan network of claim 18, wherein the payment server is configured to allocate at least a portion of the payments to a content provider.

20. The interinstitutional loan network of claim 19, wherein the content provider is a publisher.

21. The interinstitutional loan network of claim 19, wherein the content provider is the lending institution.

22. The interinstitutional loan network of claim 17, wherein the library server is unaffiliated with the lending institution.

23. The interinstitutional loan network of claim 17, wherein the library server includes a loading server configured to process content received from a publisher and to reformat the content in a form manageable by the library server.

24. A library server comprising:
a memory configured to store electronic content and access right affiliations with a plurality of institutions; and
a programmable circuit operably connected to the memory, the programmable circuit configured to execute program instructions to:
receive a request for limited-time access to electronic content from a requesting institution;
receive payment from the requesting institution;
grant a patron affiliated with the requesting institution a limited-time access right to the electronic content;
disburse at least a portion of the payment to a publisher affiliated with the content; and
disburse at least a portion of the payment to a lending institution having access to the content.

25. An electronic content loan system comprising:
a user interface accessible to a requesting institution, the user interface configurable to display a listing of electronic content for which limited-time access is available; and
an order processing system operable on a library server, the order processing system configured to receive requests for limited-time access to the content and process payments associated with those requests;
wherein the order processing system allocates a portion of the payments to a publisher of the content.

26. The electronic content loan system of claim 25, wherein the order processing system is hosted by a library server.

27. The electronic content loan system of claim 26, wherein the library server is unaffiliated with the requesting institution.

28. An electronic content loan system facilitating interinstitutional access of electronic content between a lending institution and a requesting institution, the electronic content loan system comprising:
a library server communicatively connected to an interinstitutional loan network, the library server configured to control access to electronic content affiliated with a lending institution in the interinstitutional loan network, the library server including a programmable circuit configured to execute machine instructions to:
generate a user interface accessible to a requesting institution, the user interface configurable to display a listing of electronic content available to the library server, the electronic content including content for which limited-time access is available;
receive interinstitutional loan requests from a requesting institution;
provide access to the electronic content to the requesting institution from the lending institution;
a payment processing server communicatively connected to the library server, the payment processing server configured to process payments associated with the requests.

29. The electronic content loan system of claim 28, wherein the user interface is accessible to a plurality of requesting institutions.

30. The electronic content loan system of claim 28, wherein interinstitutional loan requests can be received at the library server from any of the plurality of requesting institutions.

31. A method of providing access to electronic content owned by a lending institution to a requesting institutions from among a plurality of possible requesting institutions, the method comprising:
receiving a request from a requesting institution at a library server for limited-time access to electronic content, the electronic content owned by a lending institution separate from the library server;
receiving payment from the requesting institution at a payment processing server communicatively connected to the library server;
in response to receiving payment from the requesting institution, granting to a patron computing system affiliated with the requesting institution a limited-time access right to the electronic content from the library server;
disbursing at least a portion of the payment from the payment processing server to a publisher affiliated with the content; and
disbursing at least a portion of the payment from the payment processing server to a lending institution having access to the content.

32. The method of claim 31, further comprising, upon expiration of the limited-time access right, preventing access to the electronic content by the patron computing system.

33. The method of claim 31, wherein granting to a patron computing system affiliated with the requesting institution a limited-time access right to the electronic content includes associating an identifier of the requesting institution with a record of the electronic content.

34. The method of claim 33, further comprising transmitting a message to the patron computing system a message including a link configured to activate the limited-time access right.
